(19) United States
(12) Patent Application Publication
(10) Pub. No.: US 2013/0302506 A1
(43) Pub. Date: Nov. 14, 2013

(54) AQUACULTURE FEED COMPOSITIONS

(71) Applicant: E I DU PONT DE NEMOURS AND COMPANY, Wilmington, DE (US)

(72) Inventors: Scott E. Nichols, WEST CHESTER, PA (US); J. Martin Odom, KENNETT SQUARE, PA (US)

(21) Appl. No.: 13/934,650

(22) Filed: Jul. 3, 2013

Related U.S. Application Data
(63) Continuation of application No. 12/854,449, filed on Aug. 11, 2010.

(51) Int. Cl. A23K 1/16

(52) U.S. Cl. CPC A23K 1/164
USPC 426/655

(57) ABSTRACT

Aquaculture feed compositions having a ratio of concentration of ω-3 polyunsaturated fatty acids of eicosapentaenoic acid [“EPA”; cis-5,8,11,14,17-eicosapentaenoic acid; 20:5] to concentration of docosahexaenoic acid [“DHA”; cis-4,7,10,13,16,19-docosahexaenoic acid; 22:6] greater than 2:1 based on the individual concentrations of EPA and DHA in the aquaculture feed composition are disclosed. Furthermore, such aquaculture feed compositions may have a concentration of the sum of EPA and DHA that is at least about 0.8%, measured as a weight percent of the aquaculture feed composition.

### FIELD OF THE INVENTION

This invention is in the field of aquaculture. More specifically, this invention pertains to aquaculture feed compositions with omega-3 polyunsaturated fatty acid ratios of eicosapentaenoic acid to docosahexaenoic acid that are higher than currently available using fish oil.

### BACKGROUND OF THE INVENTION

Aquaculture is a form of agriculture that involves the propagation, cultivation and marketing of aquatic animals and plants in a controlled environment. The history of aquaculture in the United States can be traced back to the mid to late 19^{th} century, when pioneers began to supply brood fish, fingerlings and lessons in fish husbandry to would-be aquaculturists. Until the early 1960's, commercial fish culture in the United States was mainly restricted to rainbow trout, bait fish and a few warmwater species (e.g., buffaloes, bass and crappies).

The aquaculture industry is currently the fastest growing food production sector in the world. World aquaculture produces approximately 60 million tons of seafood, which is worth more than $70 billion (US) annually. Today, farmed fish accounts for approximately 50% of all fish consumed globally. This percentage is expected to increase, as a result of dwindling catches from capture fisheries in both marine and freshwater environments and increasing seafood consumption (i.e., total and per capita). Today, species groups in aquaculture production include, for example: carps and other cyprinids; oysters; clams, cockles and arkshells; shrimps amd prawns; salmons, trouts and smelts; mussels; tilapias and other cichlids; and scallops and pectens.

While some aquacultured species (e.g., Tilapia) can be fed on an entirely vegetarian diet, many others species are fed a carnivorous diet. Typically, the feed for carnivorous fish comprises fishmeal and fish oil derived from wild caught species of small pelagic fish (predominantly anchovy, jack mackerel, blue whiting, capelin, sandeel and menhaden). These pelagic fish are processed into fishmeal and fish oil, with the final product often being either a pelleted or flaked feed, depending on the size of the fish (e.g., fry, juveniles, adults). The other components of the aquaculture feed composition may include vegetable protein, vitamins, minerals and pigment as required.

Marine fish oils have traditionally been used as the sole dietary lipid source in commercial fish feed given their ready availability, competitive price and the abundance of essential fatty acids contained within this product. Additionally, fish oils readily supply essential fatty acids which are required for regular growth, health, reproduction and bodily functions within fish. More specifically, all vertebrate species, including fish, have a dietary requirement for both omega-6 and omega-3 polyunsaturated fatty acids [“PUFAs”]. Eicosapentaenoic acid [“EPA”; cis-5,8,11,14,17-eicosapentaenoic acid; ω-3] and docosahexaenoic acid [“DHA”; cis-4,7, 10, 13, 16, 19-docosahexaenoic acid; 22:6 ω-3] are required for fish growth and health and are often incorporated into commercial fish feeds via addition of fish oils.

It is estimated that aquaculture feed compositions currently use about 87% of the global supply of fish oil as a lipid source. Since annual fish oil production has not increased beyond 1.5 million tons per year, the rapidly growing aquaculture industry cannot continue to rely on finite stocks of marine pelagic fish as a supply of fish oil. Thus, there is great urgency to find and implement sustainable alternatives to fish oil that can keep pace with the growing global demand for fish products.

Many organizations recognize the limitations noted above with respect to fish oil availability and aquaculture sustainability. For example, in the United States, the National Oceanic and Atmospheric Administration is partnering with the Department of Agriculture in an Alternative Feeds Initiative to “ . . . identify alternative dietary ingredients that will reduce the amount of fishmeal and fish oil contained in aquaculture fees while maintaining the important human health benefits of farmed seafood”.

U.S. Pat. Appl. Pub. No. 2006-0115881-A1 suggests recombinantly engineered Yarrowia lipolytica may be a useful addition to most animal feeds, including aquaculture feeds, as a means to provide necessary omega-3 and/or omega-6 PUFAs and based on its unique protein:lipid:carbohydrate composition, as well as unique complex carbohydrate profile (comprising an approximate 1:4:4.6 ratio of mannan:beta-glucans:chitin).

U.S. Pat. Appl. Pub. No. 2007/0226814 discloses fish food containing at least one biomass obtained from fermenting microorganisms wherein the biomass contains at least 20% DHA relative to the total fatty acid content. Preferred microorganisms used as sources for DHA are organisms belonging to the Stramenopiles.

U.S. Pat. Appl. Pub. No. 2009/0202672 discloses, inter alia, aquaculture feed incorporating oil obtained from a transgenic plant engineered to produce stearidonic acid [“SDA”; 18:4 ω-3]. However, SDA is converted with low efficiency to DHA in fish.

If the growing aquaculture industry is to sustain its contribution to world fish supplies, then it needs to reduce wild fish inputs in feed and adopt more ecologically sound management practices.

### SUMMARY OF THE INVENTION

In one embodiment, the invention concerns an aquaculture feed composition comprising:

(a) at least one source of eicosapentaenoic acid [“EPA”] and optionally at least one source of docosahexanoic acid [“DHA”], wherein said source can be the same or different; and,

(b) a ratio of concentration of EPA to concentration of DHA which is greater than 2:1 based on the individual concentrations of EPA and DHA in the aquaculture feed composition.

In a second embodiment, the invention concerns an aquaculture feed composition wherein the aquaculture composition further comprises a total amount of EPA and DHA that is at least about 0.8% measured as a weight percent of the aquaculture feed composition.

In a third embodiment, the invention concerns an aquaculture feed composition wherein the at least one source of EPA is a first source that is microbial oil and an optional second source that is fish oil or fish meal.

In a fourth embodiment, the invention concerns an aquaculture feed composition wherein the at least one source of DHA is selected from the group consisting of microbial oil, fish oil, fish meal, and a combination thereof.

In a fifth embodiment, the invention concerns an aquaculture feed composition wherein the microbial oil is provided in a form selected from the group consisting of biomass, processed biomass, partially purified oil and purified oil, any of which is obtained from at least one transgenic microbe engineered for the production of polyunsaturated fatty acid-containing microbial oil comprising EPA. Preferably, the at least one transgenic microbe is cultured. The preferred transgenic microbe is Yarrowia lipolytica.

In a sixth embodiment, the invention concerns an aquaculture feed composition wherein the biomass, processed biomass, partially purified oil and/or purified oil are obtained from the cultured transgenic microbe.

In a seventh embodiment, the invention concerns an aquaculture feed composition which further comprises at least one vegetable oil.

In an eighth embodiment, the invention concerns a method of making an aquaculture feed composition comprising:
a) providing at least one source of EPA and optionally at least one source of DHA, wherein said source can be the same or different;
b) providing additional feed components; and,
c) contacting (a) and (b) to make an aquaculture feed composition;

wherein said aquaculture feed composition has a ratio of concentration of EPA to concentration of DHA which is greater than 2:1 based on the individual concentrations of EPA and DHA in the aquaculture feed composition.

In a ninth embodiment, the invention concerns a method of making an aquaculture feed composition wherein the aquaculture composition further comprises a total amount of EPA and DHA that is at least about 0.8% measured as weight percent of the aquaculture feed composition.

### DETAILED DESCRIPTION

All patents, patent applications, and publications cited herein are incorporated by reference in their entirety.

In this disclosure, a number of terms and abbreviations are used.

The following definitions are provided.

‘“Polyunsaturated fatty acid(s)” is abbreviated as “PUFA(s)”.

“Triacylglycerols” are abbreviated as “TAGs”.

“Total fatty acids” are abbreviated as “TFAs”.

“Fatty acid methyl esters” are abbreviated as “FAMEs”.

“Dry cell weight” is abbreviated as “DCW”.

As used herein the term “invention” or “present invention” is intended to refer to all aspects and embodiments of the invention as described in the claims and specification herein and should not be read so as to be limited to any particular embodiment or aspect.

The terms “aquaculture feed composition”, “aquaculture feed formulation”, “aquaculture feed” and “aquafeed” are used interchangeably herein. They refer to manufactured or artificial diets (i.e., formulated feeds) to supplement or to replace natural feeds in the aquaculture industry. These prepared foods are most commonly produced in flake, pellet or tablet form. Typically, an aquaculture feed composition refers to artificially compounded feeds that are useful for farmed finfish and crustaceans (i.e., both lower-value staple food fish species [e.g., freshwater finfish such as carp, tilapia and catfish] and higher-value cash crop species for luxury or niche markets [e.g., mainly marine and diadromous species such as shrimp, salmon, trout, yellowtail, seabass, seabream and grouper]). These formulated feeds are composed of several ingredients in various proportions complementing each other to form a nutritionally complete diet for the aquacultured species.

An aquaculture feed composition is used in the production of an “aquaculture product”, wherein the product is a harvestable aquacultured species (e.g., finfish, crustaceans), which is often sold for human consumption. For example, salmon are intensively produced in aquaculture and thus are aquaculture products.

The term “aquaculture meat product” refers to food products intended for human consumption comprising at least a portion of meat from an aquaculture product as defined above. An aquaculture meat product may be, for example, a whole fish or a filet cut from a fish that is each sold as food. “Eicosapentaenoic acid” [“EPA”] is the common name for cis-5,8,11,14,17-eicosapentaenoic acid. This fatty acid is a 20:5 omega-3 fatty acid. The term EPA as used in the present disclosure will refer to the acid or derivatives of the acid (e.g., glycerides, esters, phospholipids, amides, lactones, salts or the like) unless specifically mentioned otherwise.

“Docosahexaenoic acid” [“DHA”] is the common name for cis-4,7, 10, 13, 16, 19-docosahexaenoic acid. This fatty acid is a 22:6 omega-3 fatty acid. The term DHA as used in the present disclosure will refer to the acid or derivatives of the acid (e.g., glycerides, esters, phospholipids, amides, lactones, salts or the like) unless specifically mentioned otherwise.

As used herein the term “biomass” refers to microbial cellular material produced from the fermentation of a recombinant production host producing EPA. Preferably, EPA is produced in commercially significant amountsThe preferred production host is a recombinant strain of the oleaginous yeast, Yarrowia lipolytica. The biomass may be in the form of whole cells, whole cell lysates, homogenized cells, partially hydrolyzed cellular material, and/or partially purified cellular material (e.g., microbially produced oil). The term “processed biomass” refers to biomass that has been subjected to additional processing such as drying, pasterization, disruption, etc. All of which are discussed in greater detail below.

The term “oleaginous” refers to those organisms that tend to store their energy source in the form of lipid (Weete, In: Fungal Lipid Biochemistry, 2^{nd} Ed., Plenum, 1980). A class of plants identified as oleaginous are commonly referred to as “oilseed” plants. Examples of oilseed plants include, but are not limited to: soybean (Glycine and Soja sp.), flax (Linum sp.), rapeseed (Brassica sp.), maize, cotton, safflower (Carthamus sp.) and sunflower (Helianthus sp.).

Within oleaginous microorganisms the cellular oil or TAG content generally follows a sigmoid curve, wherein the concentration of lipid increases until it reaches a maximum at the late logarithmic or early stationary growth phase and then gradually decreases during the late stationary and death phases (Yongmanitchai and Ward, Appl. Environ. Microbiol. 57:419-25 (1991)).

The term “oleaginous yeast” refers to those microorganisms classified as yeasts that make oil. It is not uncommon for oleaginous microorganisms to accumulate in excess of about 25% of their dry cell weight as oil. Examples of oleaginous yeast include, but are no means limited to, the following genera: Yarrowia, Candida, Rhodotorula, Rhodosporidium, Cryptococcus, Trichosporon and Lipomyces.

The term “'lipids” refer to any fat-soluble (i.e., lipophilic), naturally-occurring molecule. A general overview of lipids is provided in U.S. Pat. Appl. Pub. No. 2009-0093543-A1 (see Table 2 therein).

The term “oil” refers to a lipid substance that is liquid at 25° C. and usually polyunsaturated. In oleaginous organisms, oil constitutes a major part of the total lipid. “Oil” is composed primarily of triacylglycerols [“TAGs”] but may also contain other neutral lipids, phospholipids and free fatty acids. The fatty acid composition in the oil and the fatty acid composition of the total lipid are generally similar; thus, an increase or decrease in the concentration of PUFAs in the total lipid will correspond with an increase or decrease in the concentration of PUFAs in the oil, and vice versa.

The term “extracted oil” refers to an oil that has been separated from cellular materials, such as the microorganism in which the oil was synthesized. Extracted oils are obtained through a wide variety of methods, the simplest of which involves physical means alone. For example, mechanical crushing using various press configurations (e.g., screw, expeller, piston, bead beaters, etc.) can separate oil from cellular materials. Alternatively, oil extraction can occur via treatment with various organic solvents (e.g., hexane), via enzymatic extraction, via osmotic shock, via ultrasonic extraction, via supercritical fluid extraction (e.g., CO₂ extraction), via saponification and via combinations of these methods. An extracted oil does not require that it can not be further purified or concentrated.

“Fish oil” refers to oil derived from the tissues of an oily fish. Examples of oil fish include, but are not limited to: menhaden, anchovy, cod and the like. Fish oil is a typical component of feed used in aquaculture.

“Menhaden” refer to forage fish of the genera Brevoortia and Ethmidium, two genera of marine fish in the family Clupeidae. Recent taxonomic work using DNA comparisons have organized the North American menhadens into large-scaled (Gulf and Atlantic menhaden) and small-scaled (Finescale and Yellowfin menhaden) designations (Anderson, J. D., Fishery Bulletin, 105(3):368-378).

“Anchovies” from which anchovy fish meal and anchovy fish oil are produced, are a family (Engraulidae) of small, common salt-water forage fish. There are about 140 species in 16 genera, found in the Atlantic, Indian, and Pacific Oceans.

“Vegetable oil” refers to any edible oil obtained from a plant. Typically plant oil is extracted from seed or grain of a plant.

The term “triacylglycerols” [“TAGs”] refers to neutral lipids composed of three fatty acyl residues esterified to a glycerol molecule. TAGs can contain long chain PUFAs and saturated fatty acids, as well as shorter chain saturated and unsaturated fatty acids.

“Neutral lipids” refer to those lipids commonly found in cells in lipid bodies as storage fats and are so called because at cellular pH, the lipids bear no charged groups. Generally, they are completely non-polar with no affinity for water. Neutral lipids generally refer to mono-, di-, and/or triesters of glycerol with fatty acids, also called monoacylglycerol, diacylglycerol or triacylglycerol, respectively, or collectively, acylglycerols. A hydrolysis reaction must occur to release free fatty acids from acylglycerols.

The term “total fatty acids” [“TFAs”] herein refer to the sum of all cellular fatty acids that can be derivitized to fatty acid methyl esters [“FAMEs”] by the base transesterification method (as known in the art) in a given sample, which may be the biomass or oil, for example. Thus, total fatty acids include fatty acids from neutral lipid fractions (including diacylglycerols, monoacylglycerols and TAGs) and from polar lipid fractions (including, e.g., the phosphatidylcholine and phosphatidylethanolamine fractions) but not free fatty acids.

The term “total lipid content” of cells is a measure of TFAs as a percent of the dry cell weight [“DCW”], athough total lipid content can be approximated as a measure of FAMEs as a percent of the DCW [“FAMEs % DCW”]. Thus, total lipid content [“TFAs % DCW”] is equivalent to, e.g., milligrams of total fatty acids per 100 milligrams of DCW.

The concentration of a fatty acid in the total lipid is expressed herein as a weight percent of TFAs (% TFAs), e.g., milligrams of the given fatty acid per 100 milligrams of TFAs. Unless otherwise specifically stated in the disclosure herein, reference to the percent of a given fatty acid with respect to total lipids is equivalent to concentration of the fatty acid as TFAs (e.g., % EPA of total lipids is equivalent to EPA % TFAs).

In some cases, it is useful to express the content of a given fatty acid(s) in a cell as its weight percent of the dry cell weight (% DCW). Thus, for example, eicosapentaenoic acid % DCW would be determined according to the following formula: (eicosapentaenoic acid % TFAs)*(TFAs % DCW)]/100. The content of a given fatty acid(s) in a cell as its weight percent of the dry cell weight (% DCW) can be approximated, however, as: (eicosapentaenoic acid % TFAs)*(FAMEs % DCW)]/100.

The terms “lipid profile” and “lipid composition” are interchangeable and refer to the amount of individual fatty acids contained in a particular lipid fraction, such as in the total lipid or the oil, wherein the amount is expressed as a weight percent of TFAs. The sum of each individual fatty acid present in the mixture should be 100.

The term “blended oil” refers to an oil that is obtained by admixing, or blending, the extracted oil described herein with any combination of, or individual, oil to obtain a desired composition. Thus, for example, types of oils from different microbes can be mixed together to obtain a desired PUFA composition. Alternatively, or additionally, the PUFA-containing oils disclosed herein can be blended with fish oil, vegetable oil or a mixture of both to obtain a desired composition.

The term “fatty acids” refers to long chain aliphatic acids (alkanoic acids) of varying chain lengths, from about C₁₂ to C₂₂, although both longer and shorter chain-length acids are known. The predominant chain lengths are between C₁₆ and C₂₂. The structure of a fatty acid is represented by a simple notation system of “X:Y”, where X is the total number of carbon [“C”] atoms in the particular fatty acid and Y is the number of double bonds. Additional details concerning the differentiation between “saturated fatty acids” versus “unsaturated fatty acids”, “monounsaturated fatty acids” versus “polyunsaturated fatty acids” [“PUFAs”], and “omega-6 fatty acids” [“ω-6” or “n-6”] versus “omega-3 fatty acids” [“ω-3” or “n-3”] are provided in U.S. Pat. No. 7,238,482, which is hereby incorporated herein by reference.

Nomenclature used to describe PUFAs herein is given in Table 1. In the column titled “Shorthand Notation”, the omega-reference system is used to indicate the number of carbons, the number of double bonds and the position of the double bond closest to the omega carbon, counting from the omega carbon, which is numbered 1 for this purpose. The remainder of the Table summarizes the common names of ω-3 and ω-6 fatty acids and their precursors, the abbreviations that will be used throughout the specification and the chemical name of each compound.

TABLE 1
Nomenclature of Polyunsaturated Fatty Acids And Precursors

| | | | Shorthand |
|---|---|---|---|
| Common Name | Abbreviation | Chemical Name | Notation |
| Myristic | — | tetradecanoic | 14:0 |
| Palmitic | Palmitate | hexadecanoic | 16:0 |
| Palmitoleic | — | 9-hexadecenoic | 16:1 |
| Stearic | — | octadecanoic | 18:0 |
| Oleic | — | cis-9-octadecenoic | 18:1 |
| Linoleic | LA | cis-9,12-octadecadienoic | 18:2 ω-6 |
| γ-Linolenic | GLA | cis-6,9,12-octadecatrienoic | 18:3 ω-6 |
| Eicosadienoic | EDA | cis-11,14-eicosadienoic | 20:2 ω-6 |
| Dihomo-γ- | DGLA | cis-8,11,14-eicosatrienoic | 20:3 ω-6 |
| Linolenic | | | |
| Arachidonic | ARA | cis-5,8,11,14- | 20:4 ω-6 |
| | | eicosatetraenoic | |
| α-Linolenic | ALA | cis-9,12,15- | 18:3 ω-3 |
| | | octadecatrienoic | |
| Stearidonic | STA | cis-6,9,12,15- | 18:4 ω-3 |
| | | octadecatetraenoic | |
| Eicosatrienoic | ETrA | cis-11,14,17-eicosatrienoic | 20:3 ω-3 |
| Eicosa- | ETA | cis-8,11,14,17- | 20:4 ω-3 |
| tetraenoic | | eicosatetraenoic | |
| Eicosa- | EPA | cis-5,8,11,14,17- | 20:5 ω-3 |
| pentaenoic | | eicosapentaenoic | |
| Docosa- | DTA | cis-7,10,13,16- | 22:4 ω-6 |
| tetraenoic | | docosatetraenoic | |
| Docosa- | DPAn-6 | cis-4,7,10,13,16- | 22:5 ω-6 |
| pentaenoic | | docosapentaenoic | |
| Docosa- | DPA | cis-7,10,13,16,19- | 22:5 ω-3 |
| pentaenoic | | docosapentaenoic | |
| Docosa- | DHA | cis-4,7,10,13,16,19- | 22:6 ω-3 |
| hexaenoic | | docosahexaenoic | |

As used herein, “transgenic” or “genetically engineered” refers to a microbe, plant or a cell which comprises within its genome a heterologous polynucleotide. Preferably, the heterologous polynucleotide is stably integrated within the genome such that the polynucleotide is passed on to successive generations. The heterologous polynucleotide may be integrated into the genome alone or as part of an expression construct. Thus, transgenic is used herein to include any microbe, cell, cell line, and/or tissue, the genotype of which has been altered by the presence of heterologous nucleic acid.

“Fish meal” refers to a protein source for aquaculture feed compositions. Fish meals are typcially either produced from fishery wastes associated with the processing of fish for human consumption (e.g., salmon, tuna) or produced from specific fish (i.e., herring, menhaden, pollack) which are harvested solely for the purpose of producing fish meal.

Aquaculture involves cultivating aquatic populations (e.g., freshwater and saltwater organisms) under controlled conditions. Organisms grown in aquaculture may include fish and crustaceans. Crustaceans are, for example, lobsters, crabs, shrimp, prawns and crayfish. The farming of finfish is the most common form of aquaculture. It involves raising fish commercially in tanks, ponds, or ocean enclosures, usually for food. A facility that releases juvenile fish into the wild for recreational fishing or to supplement a species' natural numbers is generally referred to as a fish hatchery. Particularly of interest are fish of the salmonid group, for example, cherry salmon (Oncorhynchus masou), Chinook salmon (Oncorhynchus tshawytscha), chum salmon (Oncorhynchus keta), coho salmon (Oncorhynchus kisutch), pink salmon (Oncorhynchus gorbuscha), sockeye salmon (Oncorhynchus nerka) and Atlantic salmon (Salmo salar). Other finfish of interest for aquaculture include, but are not limited to, various trout, as well as whitefish such as tilapia (including various species of Oreochromis, Sarotherodon, and Tilapia), grouper (subfamily Epinephelinae), sea bass, catfish (order Siluriformes), bigeye tuna (Thunnus obesus), carp (family Cyprimidae) and cod (genus Gadus).

Aquaculture typcially requires a prepared aquaculture feed composition to meet dietary requirements of the cultured animals. Dietary requirements of different aquaculture species vary, as do the dietary requirements of a single species during different stages of growth. Thus, tremendous research is invested towards optimizing each aquaculture feed composition for each stage of growth of a cultured organism.

As an example, one can consider the 6-phase life cycle of salmon. In the wild, the salmon life cycle begins with the fertilization of spawned eggs. The eggs hatch into “alevin”, which live off the nutritious yolk sac that hangs off their undersides for several months. Then, alevin develop into “fry”, which feed mainly on zooplankton until they grow large enough to eat aquatic insects and other larger foods. When the fry are several months to 1 year old, they develop very noticeable markings along their flanks. They are then termed salmon “parr”, which feed mainly on freshwater terrestrial and aquatic insects, amphipods, worms, crustaceans, amphibian larvae, fish eggs, and young fish for 1 to 3 years. The process of smolting, which normally occurs when the fish are 12-18 months old, enables the “smolts” to transition from a freshwater environment to open salt water seas. Adult salmon feed on smaller fish, such as herring, sandeels, pelagic amphipods and krill while in the open ocean; they will return to the rivers in which they were born after being at sea for 1-4 yr.

In aquaculture, salmon are typically farmed in two stages. In the first stage, fish are hatched from eggs and raised in freshwater tanks for 12-18 months to the smolt stage. Alternatively, spawning channels, or artificial streams, may be used in the first stage. In the second stage, the smolts are transferred to floating sea cages or net pens which are anchored in bays or fjords along a coast. Cages or pens are provided with feed delivery equipment. Aquacultured animals may be fed different aquaculture feed compositions that are formulated to meet the changing nutrient requirements needed during different stages of growth (Handbook of Salmon Farming; Stead and Laird (eds) (2002) Praxis Publishing Ltd., Chichester, UK). The present aquaculture feed compositions may be fed to animals to support their growth by any method of aquaculture known by one skilled in the art (“Food for Thought: the Use of Marine Resources in Fish Feed” Editor: Tveferaas, head of conservation, WWF-Norway, Report #02/03 (2/2003)).

Once the aquaculture animals reach an appropriate size, the crop is harvested, processed to meet consumer requirements, and can be shipped to market, generally arriving within hours of leaving the water.

For example, a common harvesting method for aquacultured fish is to use a sweep net, which operates a bit like a purse seine net. The sweep net is a big net with weights along the bottom edge. It is stretched across the pen with the bottom edge extending to the bottom of the pen. Lines attached to the bottom corners are raised, herding some fish into the purse, where they are netted. More advanced systems use a percussive-stun harvest system that kills the fish instantly and humanely with a blow to the head from a pneumatic piston. They are then bled by cutting the gill arches and immediately immersed in iced water. Harvesting and killing methods are designed to minimize scale loss, and avoid the fish releasing stress hormones, which negatively affect flesh quality.

To produce a salmon of harvestable size (i.e., 2.5-4 kg), appropriate aquaculture feed compositions may be formulated as appropriate over the dietary cycles of the salmon. Commercial feeds generally rely on available supplies of fish oil to provide energy and specific fatty acid requirements for aquacultured fish. Generally, it takes between 3-7 kg, with the average around 5 kg, of captured pelagic fish to provide the fish oil necessary to produce one kg of salmon. Thus, the limited global supply of fish oil will ultimately limit growth of aquaculture industries. Additionally, removal of large numbers of smaller species of fish from the food chain can have adverse ecosystem affects.

Aquaculture feed compositions are composed of micro and macro components. In general, all components, which are used at levels of more than 1%, are considered as macro components. Feed ingredients used at levels of less than 1% are micro components. They have to be premixed to achieve a homogeneous distribution of the micro components in the complete feed. Both macro and micro ingredients are subdivided into components with nutritional functions and technical functions. Components with technical functions improve the physical quality of the aquaculture feed composition or its appearance.

Macro components with nutritional functions provide aquatic animals with protein and energy required for growth and performance. With respect to fish, the aquaculture feed composition should ideally provide the fish with: 1) fats, which serve as a source of fatty acids for energy (especially for heart and skeletal muscles); and, 2) amino acids, which serve as building blocks of proteins. Fats also assist in vitamin absorption; for example, vitamins A, D, E and K are fat-soluble or can only be digested, absorbed, and transported in conjunction with fats. Carbohydrates, typically of plant origin (e.g., wheat, sunflower meal, corn gluten, soybean meal), are also often included in the feed compositions, although carbohydrates are not a superior energy source for fish over protein or fat.

Fats are typically provided via incorporation of fish meals (which contain a minor amount of fish oil) and fish oils into the aquaculture feed compositions. Extracted oils that may be used in aquaculture feed compositions include fish oils (e.g., from the oily fish menhaden, anchovy, herring, capelin and cod liver), and vegetable oil (e.g., from soybeans, rapeseeds, sunflower seeds and flax seeds). Typically, fish oil is the preferred oil, because it contains the long chain omega-3 polyunsaturated fatty acids [“PUFAs”], EPA and DHA; in contrast, vegetable oils do not provide a source of EPA and/or DHA. These PUFAs are needed for growth and health of most aquaculture products. A typical aquaculture feed composition will comprise from about 15-30% of oil (e.g., fish, vegetable, etc.), measured as a weight percent of the aquaculture feed composition.

The amount of EPA (as a percent of total fatty acids [“% TFAs”]) and DHA % TFAs provided in typical fish oils varies, as does the ratio of EPA to DHA. Typical values are summarized in Table 2, based on the work of Turchini, Torstensen and Ng (Reviews in Aquaculture 1:10-57 (2009)):

TABLE 2
Typical EPA And DHA Content In Various Fish Oils

| Fish Oil | EPA | DHA | EPA:DHA Ratio |
|---|---|---|---|
| Anchovy oil | 17% | 8.8% | 1.93 |
| Capelin oil | 4.6% | 3.0% | 1.53 |
| Menhaden oil | 11% | 9.1% | 1.21 |
| Herring oil | 8.4% | 4.9% | 1.71 |
| Cod liver oil | 11.2% | 12.6% | 0.89 |

Often, oil from fish that are have lower EPA:DHA ratios is used in aquaculture feed compositions, due to the lower cost. Anchovy oil has the highest EPA:DHA ratio; however, using this oil as the sole oil source in an aquaculture feed composition would result in an EPA:DHA ratio of less than 2:1 in the final formulation.

The protein supplied in aquaculture feed compositions can be of plant or animal origin. For example, protein of animal origin can be from marine animals (e.g., fish meal, fish oil, fish protein, krill meal, mussel meal, shrimp peel, squid meal, squid oil, etc.) or land animals (e.g., blood meal, egg powder, liver meal, meat meal, meat and bone meal, silkworm, pupae meal, whey powder, etc.). Protein of plant origin can include vegetable oil, lecithin, rice and the like.

The technical functions of macro components are overlapping as, for example, wheat gluten may be used as a pelleting aid and for its protein content, which has a relatively high nutitional value. There can also be mentioned guar gum and wheat flour.

Micro components include feed additives such as vitamins, trace minerals, feed antibiotics and other biologicals. Minerals used at levels of less than 100 mg/kg (100 ppm) are considered as micro minerals or trace minerals.

Micro components with nutritional functions are all biologicals and trace minerals. They are involved in biological processes and are needed for good health and high performance. There can be mentioned vitamins such as vitamins A, E, K₃, D₃, B₁, B₃, B₆, B₁₂, C, biotin, folic acid, panthothenic acid, nicotinic acid, choline chloride, inositiol, para-amino-benzoic acid. There can be mentioned minerals such as salts of calcium, cobalt, copper, iron, magnesium, phosophorus, potasium, selenium and zinc. Other components may include, but are not limited to, antioxidants, beta-glucans, bile salt, cholesterol, enzymes, monosodium glutamate, etc.

The technical functions of micro ingredients are mainly related to pelleting, detoxifying, mould prevention, antioxidation, etc.

The present invention concerns a sustainable alternative to fish oil. Specifically, the invention concerns an aquaculture feed composition comprising: (a) at least one source of EPA and optionally at least one source of DHA, wherein said source can be the same or different; and, (b) a ratio of concentration of EPA to concentration of DHA which is greater than 2:1 based on the individual concentrations of EPA and DHA, each measured as a weight percent of total fatty acids in the aquaculture feed composition.

The aquaculture feed composition may further comprise a total amount of EPA and DHA that is at least about 0.8%, measured as weight percent of the aquaculture feed composition. This amount (i.e., 0.8%) is typically an appropriate minimal concentration that is suitable to support the growth of a variety of animals grown in aquaculture, and particularly is suitable for inclusion in the diets of salmonid fish.

As previously discussed, the highest EPA:DHA ratio in fish oil (i.e., anchovy oil) was 1.93:1 (Turchini, Torstensen and Ng, supra). Thus, it is believed that no commercially available aquaculture feed composition has been produced having an EPA:DHA ratio greater than 1.93:1. To achieve an EPA:DHA ratio greater than 2:1, as described herein, an alternate source of EPA (and optionally DHA) is required. If no DHA is present in the aquaculture feed composition, then the EPA:DHA ratio may be considered to be greater than 2:1.

In preferred embodiments of the invention here, the aquaculture feed composition comprises a microbial oil comprising EPA. This may optionally be used in combination with fish oil or fish meal (thereby effectively reducing the total amount of fish oil or fish meal that is required in the feed formulation, while maintaining desired EPA content). The microbial oil comprising EPA may also contain DHA; or, DHA may be obtained from a second microbial oil, fish oil, fish meal, and combinations thereof. In some formulations, the microbial oil comprising EPA may be supplemented with a vegetable oil, to reach the desired total oil/fat content.

EPA can be produced microbially via numerous different processes, based on the natural abilities of the specific microbial organism utilized [e.g., heterotrophic diatoms Cyclotella sp. and Nitzschia sp. (U.S. Pat. No. 5,244,921); Pseudomonas, Alteromonas or Shewanella species (U.S. Pat. No. 5,246,841); filamentous fungi of the genus Pythium (U.S. Pat. No. 5,246,842); or Mortierella elongata, M. exigua, or M. hygrophila (U.S. Pat. No. 5,401,646)]. One of skill in the art will be able to identity other microbes which have the native ability to produce EPA, based on phenotypic analysis, GC analysis of the PUFA products, review of available public and patent literature and screening of microbes related to those previously identified as EPA-producers. Microbial oils comprising EPA from these organisms may be provided in a variety of forms for use in the aquaculture feed compositions herein, wherein the oil is typically contained within microbial biomass or processed biomass, or the oil is partially purified or purified oil. In most cases, it will be most cost effective to incorporate microbial biomass or processed biomass into the aquaculture feed composition, as opposed to the microbial oil (in partial or purified form); however, these economics should not be considered as a limitation herein.

Alternately, microbial oil comprising EPA can be produced in transgenic microbes engineered for the production of polyunsaturated fatty acid-containing microbial oil comprising EPA. Microbes such as algae, fungi, yeast, stramenopiles and bacteria may be engineered for production of PUFAs, including EPA, by integration of appropriate heterologous genes encoding desaturases and elongases of either the delta-6 desaturase/delta-6 elongase pathway or the delta-9 elongase/delta-8 desaturase pathway into the host organism. The particular genes included within a particular expression cassette depend on the host organism, its PUFA profile and/or desaturase/elongase profile, the availability of substrate and the desired end product(s). A PUFA polyketide synthase [“PKS”] system that produces EPA, such as that found in e.g., Shewanella putrefaciens (U.S. Pat. No. 6,140,486), Shewanella olleyana (U.S. Pat. No. 7,217,856), Shewanella japonica (U.S. Pat. No. 7,217,856) and Vibrio marinus (U.S. Pat. No. 6,140,486), could also be introduced into a suitable microbe to enable EPA, and optionally DHA, production. Other PKS systems that natively produce DHA could also be engineered to enable only EPA or a suitable combination of the PUFAs to yield an EPA:DHA ratio of greater than 2:1.

One skilled in the art is familiar with the considerations and techniques necessary to introduce one or more expression cassettes encoding appropriate enzymes for EPA biosynthesis into a microbial host organism of choice, and numerous teachings are provided in the literature to one of skill. Microbial oils comprising EPA from these genetically engineered organisms may also be suitable for use in the aquaculture feed compositions herein, wherein the oil may be contained within the microbial biomass or processed biomass, or the oil may be partially purified or purified oil.

In some applications, the microbe engineered for EPA production is is oleaginous, i.e., the organism tends to store its energy source in the form of lipid (Weete, In: Fungal Lipid Biochemistry, 2^{nd} Ed., Plenum, 1980). Oleaginous yeast are a preferred microbe, as these microorganisms can commonly accumulate in excess of about 25% of their dry cell weight as oil. Examples of oleaginous yeast include, but are by no means limited to, the following genera: Yarrowia, Candida, Rhodotorula, Rhodosporidium, Cryptococcus, Trichosporon and Lipomyces. More specifically, illustrative oil-synthesizing yeasts include: Rhodosporidium toruloides, Lipomyces starkeyii, L. lipoferus, Candida revkaufi, C. pulcherrima, C. tropicalis, C. utilis, Trichosporon pullans, T. cutaneum, Rhodotorula glutinus, R. graminis, and Yarrowia lipolytica (formerly classified as Candida lipolytica). Most preferred is the oleaginous yeast Yarrowia lipolytica. Examples of suitable Y. lipolytica strains include, but are not limited to, Y. lipolytica strains designated as ATCC #20362, ATCC #8862, ATCC #18944, ATCC #76982 and/or LGAM S(7)1 (Papanikolaou S., and Aggelis G., Bioresour. Technol. 82(1):43-9 (2002)).

Some references describing means to engineer the oleaginous host organism Yarrowia lipolytica for EPA biosynthesis are provided as follows: U.S. Pat. No. 7,238,482, U.S. Pat. No. 7,550,286, U.S. Pat. Appl. Pub. No. 2006-0115881-A1, U.S. Pat. Appl. Pub. No. 2009-0093543-A1, U.S. patent application Ser. No. 12/814,815 (E.I. duPont de Nemours & Co., Inc., Attorney Docket No. “CL4674USNA”, filed Jun. 14, 2010 and hereby incorporated herein by reference) and U.S. patent application Ser. No. 12/814,880 (E.I. du Pont de Nemours & Co., Inc., Attorney Docket Number “CL4714USNA”, filed Jun. 14, 2010 and hereby incorporated herein by reference). This list is not exhaustive and should not be construed as limiting.

It may be desirable for the oleaginous yeast to be capable of “high-level EPA production”, wherein the organism can produce at least about 5-10% of EPA in the total lipids. More preferably, the oleaginous yeast will produce at least about 10-25% of EPA in the total lipids, more preferably at least about 25-35% of EPA in the total lipids, more preferably at least about 35-45% of EPA in the total lipids, more preferably at least about 45-55% of EPA in the total lipids, and most prefereably at least about 55-60% of EPA in the total lipids. The structural form of the EPA is not limiting; thus, for example, EPA may exist in the total lipids as free fatty acids or in esterified forms such as acylglycerols, phospholipids, sulfolipids or glycolipids.

For example, U.S. Pat. Appl. Pub. No. 2009-0093543-A1 describes high-level EPA production in optimized recombinant Yarrowia lipolytica strains. Specifically, strains are disclosed having the ability to produce microbial oils comprising at least about 43.3 EPA % TFAs, with less than about 23.6 LA % TFAs (an EPA:LA ratio of 1.83) and less than about 9.4 oleic acid (18:1) % TFAs. The preferred strain was Y4305, whose maximum production was 55.6 EPA % TFAs, with an EPA:LA ratio of 3.03. Generally, the EPA-producing strains of U.S. Pat. Appl. Pub. No. 2009-0093543-A1 comprised the following genes of the omega-3/omega-6 fatty acid biosynthetic pathway: a) at least one gene encoding delta-9 elongase; b) at least one gene encoding delta-8 desaturase; c) at least one gene encoding delta-5 desaturase; d) at least one gene encoding delta-17 desaturase; e) at least one gene encoding delta-12 desaturase; f) at least one gene encoding C_{16/18} elongase; and, g) optionally, at least one gene encoding diacylglycerol cholinephosphotransferase [“CPT1”]. Since the pathway is genetically engineered into the host cell, there is no DHA concomitantly produced due to the lack of the appropriate enzymatic activities for elongation of EPA to DPA (catalyzed by a C_{20/22} elongase) and desaturation of DPA to DHA (catalyzed by a delta-4 desaturase). The disclosure also described microbial oils obtained from these engineered yeast strains and oil concentrates thereof.

A derivative of Yarrowia lipolytica strain Y4305 is described herein, known as Y. lipolytica strain Y4305 F1B1. Upon growth in a two liter fermentation (parameters similar to those of U.S. Pat. Appl. Pub. No. 2009-009354-A1, Example 10), average EPA productivity [“EPA % DCW”] for strain Y4305 was 50-56, as compared to 50-52 for strain Y4305-F1B1. Average lipid content [“TFAs % DCW”] for strain Y4305 was 20-25, as compared to 28-32 for strain Y4305-F1B1. Thus, lipid content was increased 29-38% in strain Y4503-F1B1, with minimal impact upon EPA productivity.

More recently, U.S. patent application Ser. No. 12/814,815 (E.I. duPont de Nemours & Co., Inc., Attorney Docket No. “CL4674USNA”, filed Jun. 14, 2010) and U.S. patent application Ser. No. 12/814,880 (E.I. du Pont de Nemours & Co., Inc., Attorney Docket Number “CL4714USNA”, filed Jun. 14, 2010) teach optimized strains of recombinant Yarrowia lipolytica having the ability to produce further improved microbial oils relative to those strains described in U.S. Pat. Appl. Pub. No. 2009-0093543-A1, based on the EPA % TFAs and the ratio of EPA:LA. In addition to expressing genes of the omega-3/omega-6 fatty acid biosynthetic pathway as detailed in U.S. Pat. Appl. Pub. No. 2009-0093543-A1, these improved strains are distinguished by: a) comprising at least one multizyme, wherein said multizyme comprises a polypeptide having at least one fatty acid delta-9 elongase linked to at least one fatty acid delta-8 desaturase [a “DGLA synthase”]; b) optionally comprising at least one polynucleotide encoding an enzyme selected from the group consisting of a malonyl CoA synthetase or an acyl-CoA lysophospholipid acyltransferase [“LPLAT”]; c) comprising at least one peroxisome biogenesis factor protein whose expression has been down-regulated; d) producing at least about 50 EPA % TFAs; and, e) having a ratio of EPA:LA of at least about 3.1.

Specifically, in addition to possessing at least about 50 EPA TFAs, the lipid profile within the improved optimized strains of Yarrrowia lipolytica of U.S. patent application Ser. No. 12/814,815 and U.S. patent application Ser. No. 12/814,880, or within extracted or unconcentrated oil therefrom, will have a ratio of EPA % TFAs to LA % TFAs of at least about 3.1. Lipids produced by the improved optimized recombinant Y. lipolytica strains are also distinguished as having less than 0.5% GLA or DHA (when measured by GC analysis using equipment having a detectable level down to about 0.1%) and having a saturated fatty acid content of less than about 8%. This low percent of saturated fatty acids (i.e., 16:0 and 18:0) benefits both humans and animals.

Thus, it is considered that the EPA oils described above from genetically engineered strains of Yarrowia lipolytica are substantially free of DHA, low in saturated fatty acids and high in EPA. Example 6 herein provides a summary of some representative strains of Yarrowia lipolytica engineered to produce high levels of EPA. Furthermore, the cited art provides numerous examples of additional suitable microbial strains and species, comprising EPA and having an EPA:DHA ratio of greater than 2:1. It is also contemplated herein that any of these microbes could be subjected to further genetic engineering improvements and thus be a suitable source of EPA in the aquaculture feed compositions and methods described herein.

The aquaculture feed compositions of the present invention optionally comprise at least one source of DHA (i.e., in addition to the at least one source of EPA discussed supra). The source of DHA can be the same or different than that of EPA, although the ratio of EPA:DHA must be greater than 2:1 based on the individual concentrations of EPA and DHA, each measured as a weight percent of total fatty acids in the aquaculture feed composition.

In preferred embodiments, at least one source of DHA is selected from the group consisting of: microbial oil, fish oil, fish meal, and combinations thereof.

Fish oil is typically a source of DHA, as well as of EPA, in aquaculture feed compositions (Table 2, supra). Fish meal is also often incorporated into aquaculture feed compositions as a protein source. Since this is a fish product, the meals have a low oil content and thereby can provide a small portion of PUFAs to the total aquaculture feed composition, in addition to that provided directly as fish oil.

DHA can be produced using processes based on the natural abilities of native microbes. See, e.g., processes developed for Schizochytrium species (U.S. Pat. No. 5,340,742; U.S. Pat. No. 6,582,941); Ulkenia (U.S. Pat. No. 6,509,178); Pseudomonas sp. YS-180 (U.S. Pat. No. 6,207,441); Thraustochytrium genus strain LFF1 (U.S. 2004/0161831 A1); Crypthecodinium cohnii (U.S. Pat. Appl. Pub. No. 2004/0072330 A1; de Swaaf, M. E. et al. Biotechnol Bioeng., 81(6):666-72 (2003) and Appl Microbiol Biotechnol., 61(1):40-3 (2003)); Emiliania sp. (Japanese Patent Publication (Kokai) No. 5-308978 (1993)); and Japonochytrium sp. (ATCC #28207; Japanese Patent Publication (Kokai) No. 199588/1989)]. Additionally, the following microorganisms are known to have the ability to produce DHA: Vibrio marinus (a bacterium isolated from the deep sea; ATCC #15381); the micro-algae Cyclotella cryptica and Isochrysis galbana; and, flagellate fungi such as Thraustochytrium aureum (ATCC #34304; Kendrick, Lipids, 27:15 (1992)) and the Thraustochytrium sp. designated as ATCC #28211, ATCC #20890 and ATCC #20891. Currently, there are at least three different fermentation processes for commercial production of DHA: fermentation of C. cohnii for production of DHASCO™ (Martek Biosciences Corporation, Columbia, Md.); fermentation of Schizochytrium sp. for production of an oil formerly known as DHAGold (Martek Biosciences Corporation); and fermentation of Ulkenia sp. for production of DHActive™ (Nutrinova, Frankfurt, Germany). As such, microbial oils comprising DHA from any of these organisms may be provided in a variety of forms for use in the aquaculture feed compositions herein, wherein the oil is typically contained within microbial biomass or processed biomass, or the oil is partially purified or purified oil.

Similarly, means to genetically engineer a microbe such that it is capable of DHA production will be well known to one of skill in the art. Only two additional enzymatic steps are required to convert EPA to DHA and thus integration of appropriate heterologous genes encoding C_{20/22} elongase and delta-4 desaturase will be readily possible, using the teachings described above for engineering EPA.

Of particular import, the microbial oil may comprise a mixture of EPA and DHA to achieve the most desired ratio of EPA:DHA in the final aquaculture feed composition. Based on an increasing emphasis on the ability to engineer microorganisms for production of “designer” lipids and oils, wherein the fatty acid content and composition are carefully specified by genetic engineering for a variety of purposes, it is contemplated that a suitable microbe could be engineered producing a combination of EPA and DHA. For example, one is referred to U.S. Pat. No. 7,550,286, wherein recombinant Yarrowia lipolytica strains are disclosed having the ability to produce microbial oils comprising at least about 4.7 EPA % TFAs, 18.3 DPA % TFAs and 5.6 DHA % TFAs. Although this particular example fails to provide a microbial oil having an EPA:DHA ratio of greater than 2:1, subsequent genetic engineering could readily modify the overall lipid profile. Or, this microbial oil could be mixed with microbial oil from an alternate Yarrowia lipolytica strain producing high EPA to achieve the preferred target ratio. One of skill in the art will readily appreciate the numerous alternatives that are disclosed herein, as a means to obtain a microbial oil comprising at least one source of EPA and optionally at least one source of DHA, wherein the EPA:DHA ratio is greater than 2:1.

When a microbe (or combination of microbes) are used in the present invention as a source of EPA and/or DHA, the microbe will be grown under standard conditions well known by one skilled in the art of microbiology or fermentation science to optimize the production of the PUFA. With respect to genetically engineered microbes, the microbe will be grown under conditions that optimize expression of chimeric genes (e.g., encoding desaturases, elongases, acyltransferases, etc.) and produce the greatest and the most economical yield of EPA and/or DHA. Thus, a genetically engineered microbe producing lipids containing the desired PUFA may be cultured and grown in a fermentation medium under conditions whereby the PUFA is produced by the microorganism. Typically, the microorganism is fed with a carbon and nitrogen source, along with a number of additional chemicals or substances that allow growth of the microorganism and/or production of the PUFA. The fermentation conditions will depend on the microorganism used and may be optimized for a high content of the PUFA in the resulting biomass.

In general, media conditions may be optimized by modifying the type and amount of carbon source, the type and amount of nitrogen source, the carbon-to-nitrogen ratio, the amount of different mineral ions, the oxygen level, growth temperature, pH, length of the biomass production phase, length of the oil accumulation phase and the time and method of cell harvest.

More specifically, fermentation media should contain a suitable carbon source, such as are taught in U.S. Pat. No. 7,238,482 and U.S. Pat. Pub. No. 2009-0325265-A1. Although it is contemplated that the source of carbon utilized for growth of an engineered EPA-producing microbe may encompass a wide variety of carbon-containing sources, preferred carbon sources are sugars, glycerol and/or fatty acids. Most preferred are glucose, sucrose, invert sucrose, fructose and/or fatty acids containing between 10-22 carbons. For example, the fermentable carbon source can be selected from the group consisting of invert sucrose (i.e., a mixture comprising equal parts of fructose and glucose resulting from the hydrolysis of sucrose), glucose, fructose and combinations of these, provided that glucose is used in combination with invert sucrose and/or fructose.

Nitrogen may be supplied from an inorganic (e.g., (NH₄)₂SO₄) or organic (e.g., urea or glutamate) source. In addition to appropriate carbon and nitrogen sources, the fermentation media must also contain suitable minerals, salts, cofactors, buffers, vitamins and other components known to those skilled in the art suitable for the growth of the EPA-producing microbe and promotion of the enzymatic pathways necessary for EPA production. Particular attention is given to several metal ions (e.g., Fe⁺², Cu⁺², Mn⁺², Co⁺², Zn⁺² and Mg⁺²) that promote synthesis of lipids and PUFAs (Nakahara, T. et al., Ind. Appl. Single Cell Oils, D. J. Kyle and R. Colin, eds. pp 61-97 (1992)).

Preferred growth media are common commercially prepared media, such as Yeast Nitrogen Base (DIFCO Laboratories, Detroit, Mich.). Other defined or synthetic growth media may also be used and the appropriate medium for growth of Yarrowia lipolytica will be known by one skilled in the art of microbiology or fermentation science. A suitable pH range for the fermentation is typically between about pH 4.0 to pH 8.0, wherein pH 5.5 to pH 7.5 is preferred as the range for the initial growth conditions. The fermentation may be conducted under aerobic or anaerobic conditions.

Typically, accumulation of high levels of PUFAs in oleaginous yeast cells requires a two-stage process, since the metabolic state must be “balanced” between growth and synthesis/storage of fats. Thus, most preferably, a two-stage fermentation process is necessary for the production of EPA in Yarrowia lipolytica. This approach is described in U.S. Pat. No. 7,238,482, as are various suitable fermentation process designs (i.e., batch, fed-batch and continuous) and considerations during growth.

When the desired amount of EPA and/or DHA has been produced by the microorganism, the fermentation medium may be treated to obtain microbial biomass comprising the PUFA. For example, the fermentation medium may be filtered or otherwise treated to remove at least part of the aqueous component. The fermentation medium and/or the microbial biomass may be further processed, for example the microbial biomass may be pasteurized or treated via other means to reduce the activity of endogenous microbial enzymes that can harm the microbial oil and/or PUFA products. The microbial biomass may be subjected to drying (e.g., to a desired water content) or a means of mechanical disruption (e.g., via physical means such as bead beaters, screw extrusion, etc. to provide greater accessibility to the cell contents), or a combination of these. The microbial biomass may be granulated or pelletized for ease of handling. A brief review of downstream processing is also available by A. Singh and O. Ward (Adv. Appl. Microbiol., 45:271-312 (1997)).

Thus, micobial biomass obtained from any of the means described above may be used as a source of microbial oil comprising EPA and/or DHA for use in the aquaculture feed compositions described herein.

In some embodiments, the PUFAs may be extracted from the host cell through a variety of means well-known in the art. This may be useful, since PUFAs, including EPA, may be found in the host microorganism as free fatty acids or in esterified forms such as acylglycerols, phospholipids, sulfolipids or glycolipids. One review of extraction techniques, quality analysis and acceptability standards for yeast lipids is that of Z. Jacobs (Critical Reviews in Biotechnology, 12(5/6):463-491 (1992)). In general, extraction may be performed with organic solvents, sonication, supercritical fluid extraction (e.g., using carbon dioxide), saponification and physical means such as presses, or combinations thereof. One is referred to the teachings of U.S. Pat. No. 7,238,482 for additional details.

Thus, microbial oil, whether partially purified or purfied, obtained from any of the means described above may be used as a source of EPA and/or DHA for use in the aquaculture feed compositions described herein. Preferably, the microbial oil will be used as a replacement of at least a portion of the fish oil that would be used in a similar aquaculture feed composition.

The present invention also concerns a method of making an aquaculture feed composition comprising:
a) providing at least one source of EPA and, optionally, at least one source of DHA, wherein said source can be the same or different;
b) providing additional feed components; and,
c) contacting (a) and (b) to make an aquaculture feed composition;

wherein said aquaculture feed composition has a ratio of concentration of EPA to concentration of DHA which is greater than 2:1 based on the individual concentrations of EPA and DHA in the aquaculture feed composition.

In preferred embodiments, the at least one source of EPA is a first source that is microbial oil and an optional second source that is fish oil or fish meal. The at least one source of DHA is selected from the group consisting of: microbial oil, fish oil, fish meal, and combinations thereof.

One of skill in the art will be able to determine the appropriate amount of microbial oil comprising EPA and optionally DHA to be included in an aquaculture feed composition, to increase the EPA:DHA ratio of the resulting aquaculture feed composition to greater than 2:1 and, preferably, to result in a total amount of EPA and DHA that is at least about 0.8%, measured as a weight percent of the aquaculture feed composition. The microbial oil may be included in an aquaculture feed as partially purified or purified oil, or the microbial oil may be contained within microbial biomass or processed biomass that is included.

The amount of microbial oil, or biomass containing microbial oil, needed to achieve an EPA:DHA ratio of greater than 2:1 will vary depending on factors. Determinants include consideration of the EPA TFAs, the EPA % DCW, the DHA % TFAs and the DHA % DCW of the microbial biomass comprising the oil, the EPA % TFAs and DHA % TFAs of a purified or partially purified oil, the content of EPA and DHA in other components to be added to the aquaculture feed composition (e.g., fishmeal, fish oil, vegetable oil, microalgae oil), etc.

Exemplary calculations of EPA content, DHA content and EPA:DHA ratios in aquaculture feed compositions are provided in Example 4 (infra), based on formulation with variable concentrations (i.e., 10%, 20% And 30%) of Yarrowia lipolytica Y4305 F1B1 biomass, which was assumed to contain 15 EPA % DCW, 50 EPA % TFAs and 0.0 DHA % TFAs. More specifically, various calculations are provided to demonstrate how this microbial biomass containing EPA could readily be mixed with variable concentrations of either anchovy oil or menhaden oil (0%, 2%, 5%, 10% and 20%), to result in aquaculture feed compositions comprising from 1.8% to 10.02% total EPA and DHA in the final composition, with EPA:DHA ratios ranging from 1.94:1 up to 47.7:1.

For example, if an aquaculture feed composition is prepared comprising anchovy fishmeal (25% of total weight), anchovy oil (20% of total weight) and Yarrowia lipolytica Y4305 F1B1 biomass that provides 15 EPA % DCW (10% of total weight), the EPA:DHA ratio is calculated to be 2.69:1. With less anchovy oil and/or more Y. lipolytica Y4305 F1B1 biomass, the EPA:DHA ratio increases. In another example, if an aquaculture feed composition is prepared comprising menhaden fishmeal (25% of total weight), menhaden oil (10% of total weight) and with Yarrowia lipolytica Y4305 F1B1 biomass that provides 15 EPA % DCW (10% of total weight), EPA:DHA ratio is calculated to be 2.61:1. If fish oil is not used in the aquaculture feed composition, as seen in the scenarios using no anchovy oil or menhaden oil, then DHA will be available in the final composition only as a result of fishmeal; this leads to even higher EPA:DHA ratios.

Thus, Example 4 clearly demonstrates that a variety of aquaculture feed compositions can be formulated, using different amounts of various fish oils, in combination with different amounts of microbial biomass containing EPA, to result in a range of EPA:DHA ratios in the final aquaculture feed composition that are greater than 2:1. Similar calculations may be made for microbial biomass samples that contain various percents of EPA and/or in alternate feed formulations that comprise vegetable oils, etc. In this manner, various aquaculture feed compositions may be designed, by one skilled in the art, that have an EPA:DHA ratio of greater than 2:1. EPA:DHA ratios in the present aquaculture feed composition are greater than 2:1, and may be at least about 2.2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, or 10:1 or higher. Although preferred EPA:DHA ratios are described above, useful examples of EPA:DHA ratios include any integer or portion thereof that is greater than 2:1.

Based on the disclosure herein, it will be clear that renewable alternatives to fish oil can be utilized as a means to produce aquaculture feed compositions. These modified formulations do not impact fish health and may yield economic benefits to those performing aquaculture. Additionally, the modified formulations of the present invention will have societal benefits, as they will support sustainable aquaculture. Implementing sustainable alternatives to fish oil that can keep pace with the growing global demand for aquaculture products will also be advantageous.

### EXAMPLES

The present invention is further defined in the following Examples. It should be understood that these Examples, while indicating preferred embodiments of the invention, are given by way of illustration only. It will be understood by those skilled in the art that the invention is capable of numerous modifications, substitutions, and rearrangements without departing from the spirit of essential attributes of the invention. Reference should be made to the appended claims, rather than to the foregoing specification, as indicating the scope of the invention.

All aquaculture feed formulations and feed ingredients were obtained from and/or produced by Nofima Ingrediens, Kierreidviken 16, NO-5141 Fvllingsdalen, Norway (“Nofima”). Thus, fish meal; sunflower meal; hydrolyzed feather meal; corn gluten; soybean meal; wheat; Carophyll Pink comprising 10% astaxanthin; and yttrium oxide were obtained from Nofima.

The meaning of abbreviations is as follows: “kb” means kilobase(s), “bp” means base pairs, “nt” means nucleotide(s), “hr” means hour(s), “min” means minute(s), “sec” means second(s), “d” means day(s), “L” means liter(s), “ml” means milliliter(s), “μL” means microliter(s), “μg” means microgram(s), “ng” means nanogram(s), “mM” means millimolar, “μM” means micromolar, “nm” means nanometer(s), “μmol” means micromole(s), “DCW” means dry cell weight, “TFAs” means total fatty acids and “FAMEs” means fatty acid methyl esters.

### General Methods

Lipid Analysis:

Lipids were extracted using the Folch method (Folch et al., J. Biol. Chem., 226:497 (1957)). Following extraction, the chloroform phase was dried under N₂ and the residual lipid extract was redissolved in benzene, and then transmethylated overnight with 2,2-dimethoxypropane and methanolic HCl at room temperature, as described by Mason, M. E. and G. R. Waller (J. Agric. Food Chem., 12:274-278 (1964)) and by Hoshi et al. (J. Lipid Res., 14:599-601 (1973)). The methyl esters of fatty acids thus formed were separated in a gas chromatograph (Hewlett Packard 6890) with a split injector, a SGE BPX70 capillary column (having a length of 60 m, an internal diameter of 0.25 mm and a film thickness of 0.25 m) with flame ionization detector. The carrier gas was helium. The injector and detector temperatures were 280° C. The oven temperature was raised from 50° C. to 180° C. at the rate of 10° C./min, and then raised to 240° C. at the rate of 0.7° C./min. All GC results were analyzed using HP ChemStation software (Hewlett-Packard Co.). The relative quantity of each fatty acid present was determined by measuring the area under the peak of the FAME corresponding to that fatty acid, and calculating the percentage relative to the sum of all integrated peaks.

Yarrowia lipolytica Strains:

Y. lipolytica strain Y4305 was derived from wild type Yarrowia lipolytica ATCC #20362. Strain Y4305 was previously described in U.S. Pat. Appl. Pub. No. 2009-0093543-A1, the disclosure of which is hereby incorporated in its entirety. The final genotype of strain Y4305 with respect to wild type Yarrowia lipolytica ATCC #20362 is SCP2-(YALI0E01298g), YALI0C18711g-, Pex10-, YALI0F24167g-, unknown 1-, unknown 3-, unknown 8-, GPD::FmD12::Pex20, YAT1::FmD12::OCT, GPM/FBAIN::FmD12S::OCT, EXP1::FmD12S::Aco, YAT1::FmD12S::Lip2, YAT1::ME3S::Pex16, EXP1::ME3S::Pex20 (3 copies), GPAT::EgD9e::Lip2, EXP1::EgD9eS::Lip1, FBAINm::EgD9eS::Lip2, FBA::EgD9eS::Pex20, GPD::EgD9eS::Lip2, YAT1::EgD9eS::Lip2, YAT1::E389D9eS::OCT, FBAINm::EgD8M::Pex20, FBAIN::EgD8M::Lip1 (2 copies), EXP1::EgD8M::Pex16, GPDIN::EgD8M::Lip1, YAT1::EgD8M::Aco, FBAIN::EgD5::Aco, EXP1::EgD5S::Pex20, YAT1::EgD5S::Aco, EXP1::EgD5S::ACO, YAT1::RD5S::OCT, YAT1::PaD17S::Lip1, EXP1::PaD17::Pex16, FBAINm::PaD17::Aco, YAT1::YICPT1::ACO, GPD::YICPT1::ACO. Chimeric genes in the above strain genotype are represented by the notation system “X::Y::Z”, where X is the promoter region, Y is the coding region, and Z is the terminator, which are all operably linked to one another. Abbreviations are as follows: FmD12 is a Fusarium moniliforme delta-12 desaturase coding region [U.S. Pat. No. 7,504,259]; FmD12S is a codon-optimized delta-12 desaturase coding region derived from Fusarium moniliforme (U.S. Pat. No. 7,504,259); ME3S is a codon-optimized C_{16/18} elongase coding region derived from Mortierella alpina (U.S. Pat. No. 7,470,532); EgD9e is a Euglena gracilis delta-9 elongase coding region (U.S. Pat. No. 7,645,604); EgD9eS is a codon-optimized delta-9 elongase coding region derived from Euglena gracilis (U.S. Pat. No. 7,645,604); E389D9eS is a codon-optimized delta-9 elongase coding region derived from Eutreptiella sp. CCMP389 (U.S. Pat. No. 7,645,604); EgD8M is a synthetic mutant delta-8 desaturase coding region (U.S. Pat. No. 7,709,239) derived from Euglena gracilis (U.S. Pat. No. 7,256,033); EgD5 is a Euglena gracilis delta-5 desaturase coding region (U.S. Pat. No. 7,678,560); EgD5S is a codon-optimized delta-5 desaturase coding region derived from Euglena gracilis (U.S. Pat. No. 7,678,560); RD5S is a codon-optimized delta-5 desaturase coding region derived from Peridinium sp. CCMP626 (U.S. Pat. No. 7,695,950), PaD17 is a Pythium aphanidermatum delta-17 desaturase coding region (U.S. Pat. No. 7,556,949); PaD17S is a codon-optimized delta-17 desaturase coding region derived from Pythium aphanidermatum (U.S. Pat. No. 7,556,949); and, YICPT1 is a Yarrowia lipolytica diacylglycerol cholinephosphotransferase coding region (Inn App. Pub. No. WO 2006/052870).

Total fatty acid content of the Y4305 cells was 27.5% of dry cell weight [“TFAs % DCW”], and the lipid profile was as follows, wherein the concentration of each fatty acid is as a weight percent of TFAs [“% TFAs”]: 16:0 (palmitate)-2.8, 16:1 (palmitoleic acid)-0.7, 18:0 (stearic acid)-1.3, 18:1 (oleic acid)-4.9, 18:2 (LA)-17.6, ALA-2.3, EDA-3.4, DGLA-2.0, ARA-0.6, ETA-1.7 and EPA-53.2.

Yarrowia lipolytica strain Y4305 F1B1 was derived from Y. lipolytica strain Y4305. Specifically, strain Y4305 was subjected to transformation with a dominant, non-antibiotic marker for Y. lipolytica based on sulfonylurea resistance [“SU^{R}”]. The marker gene was a native acetohydroxyacid synthase (“AHAS” or acetolactate synthase; E.C. 4.1.3.18) that has a single amino acid change, i.e., W497L, that confers sulfonylurea herbicide resistance (SEQ ID NO:292 of Intl. App. Pub. No. WO 2006/052870). AHAS is the first common enzyme in the pathway for the biosynthesis of branched-chain amino acids and it is the target of the sulfonylurea and imidazolinone herbicides.

Random integration of the SU^{R} marker into Yarrowia strain Y4305 was used to identify those cells having increased lipid content when grown under oleaginous conditions relative to the parent Y4305 strain. Specifically, the mutated AHAS gene described above was introduced into strain Y4305 cells as a linear DNA fragment. The AHAS gene integrates randomly throughout the chromosome at any location that contains a double stranded-break that is also bound by the Ku enzymes. Non-functional genes or knockout mutations may be generated when the SU^{R} marker fragment integrates within the coding region of a gene. Every gene is a potential target fordown-regulation. Thus, a random integration library in Yarrowia Y4305 cells was made and SU^{R} mutant cells were identified. Strains were isolated and evaluated based on DCW (g/L), FAMEs % DCW, EPA % TFAs and EPA % DCW.

Strain Y4305 F1B1 had 6.9 g/L DCW, 27.9 TFAs % DCW, 53.1 EPA % TFAs, and 14.8 EPA % DCW as compared to 6.8 g/L DCW, 25.1 TFAs % DCW, 50.3 EPA % TFAs, and 12.7 EPA % DCW for the control Y4305 strain, when both strains were evaluated in triple flask analysis. When grown in a two liter fermentation (parameters similar to those of U.S. Pat. Appl. Pub. No. 2009-009354-A1, Example 10), average EPA productivity [“EPA % TFAs”] for strain Y4305 was 50-56, as compared to 50-52 for strain Y4305-F1B1. Average lipid content [“TFAs % DCW”] for strain Y4305 was 20-25, as compared to 28-32 for strain Y4305-F1B1. Thus, lipid content was increased 29-38% in strain Y4503-F1B1, with minimal impact upon EPA productivity.

Yarrowia Biomass Preparation: Inocula were prepared from frozen cultures of either Yarrowia lipolytica strain Y4305 or strain Y4305 F1B1 in a shake flask. After an incubation period, the culture was used to inoculate a seed fermenter. When the seed culture reached an appropriate target cell density, it was then used to inoculate a larger fermenter. The fermentation was run as a 2-stage fed-batch process. In the first stage, the yeast were cultured under conditions that promoted rapid growth to a high cell density; the culture medium comprised glucose, various nitrogen sources, trace metals and vitamins. In the second stage, the yeast were starved for nitrogen and continuously fed glucose to promote lipid and PUFA accumulation. Process variables including temperature (controlled between 30-32° C.), pH (controlled between 5-7), dissolved oxygen concentration and glucose concentration were monitored and controlled per standard operating conditions to ensure consistent process performance and final PUFA oil quality.

One of skill in the art of fermentation will know that variability will occur in the oil profile of a specific Yarrowia strain, depending on the fermentation run itself, media conditions, process parameters, scale-up, etc., as well as the particular time-point in which the culture is sampled (see, e.g., U.S. Pat. Appl. Pub. No. 2009-0093543-A1).

Antioxidants were optionally added to the fermentation broth prior to processing to ensure the oxidative stability of the EPA oil. After fermentation, the yeast biomass was dewatered and washed to remove salts and residual medium, and to minimize lipase activity. Prior to drum drying, ethoxyquin (600 ppm) was added to the biomass, Then, the biomass was drum dried (typically with 80 psig steam), to reduce the moisture content to less than 5% to ensure oil stability during short term storage and transportation. The drum dried biomass was in the form of flakes.

Extrusion Of Yarrowia Biomass Flakes:

Dried biomass flakes were fed into an extruder, preferably a twin screw extruder with a length suitable for accomplishing the operations described below, normally having a length to diameter [“L/D”] ratio between 21-39. The first section of the extruder was used to feed and transport the biomass. The following section served as a compaction zone designed to compact the biomass using bushing elements with progressively shorter pitch length. After the compaction zone, a compression zone followed, which served to impart most of the mechanical energy required for cell disruption. This zone was created using flow restriction, either in the form of reverse screw elements or kneading elements. Finally, the disrupted biomass was discharged through the last barrel which is open at the end, thus producing no backpressure in the extruder.

Feed Formulation:

The extruded biomass was then formulated with other feed ingredients (infra) and extruded into pellets using a 4.5 mm die opening, giving approximately 5.5 mm pellets after expansion. Yttrium oxide [Y₂O₃] (100 ppm) was added to all diets as an inert marker for digestibility determination. Vegetable oil was added post-extrusion to the pellets in accordance with the diet composition.

### Example 1

### Oil Composition of Yarrowia lipolytica Strain Y4305 F1B1 Biomass in Comparison to Fishmeal, Fish Oil and Rapeseed Oil

Yarrowia lipolytica strain Y4305 F1B1 biomass was prepared and made into flakes, as described in General Methods. Oil was extracted from the whole dried flakes by placing 7 g of dried flakes and 20 mL of hexane in a 35 mL steel cylinder. Three steel ball bearings (0.5 cm diameter) were then added to the cylinder and the cylinder was placed on a vibratory shaker. After 1 hr of vigorous shaking, the disrupted biomass was allowed to settle and the solution of oil in hexane was poured off to yield a clear yellow liquid. This liquid was then poured into a separate tube and subjected to a nitrogen stream to evaporate the hexane, thereby leaving the oil phase in the tube. It was determined that about 34% of the biomass was oil. The composition of the oil was analyzed by GC, as described in General Methods.

In addition, the fatty acid composition of fish meal oil, fish oil and rapeseed oil was similarly analyzed by GC.

Lipids were extracted as described in General Methods above.

A comparison of fatty acids present in the Yarrowia Y4305 F1B1 biomass, fish meal, fish oil, and rapeseed oil is shown in Table 3. The concentration of each fatty acid is presented as a weight percent of total fatty acids [“% TFAs”]. EPA is identified as 20:5, n-3, while DHA is identified as 22:6, n-3.

TABLE 3
Lipid Composition Of Various Oils

| | Fatty Acid | Fish | | | Yarrowia |
|---|---|---|---|---|---|
| | Common | meal | Fish | Rapeseed | Y4305 |
| Fatty acid | Name | oil | oil | oil | F1B1 oil |
| C14:0 | Myristic | 3.7 | 6.8 | 0.1 | 0.1 |
| | acid | | | | |
| C16:0 | Palmitic | 10.8 | 10.5 | 4.4 | 2.8 |
| | Acid | | | | |
| C17:0 | — | nd | nd | nd | 0.3 |
| C18:0 | Stearic | 1.7 | 1.1 | 1.8 | 2.5 |
| | acid | | | | |
| C20:0 | — | 0.1 | 0.1 | 0.6 | 0.8 |
| C22:0 | — | <0.1 | 0.1 | 0.3 | 1.1 |
| C24:0 | — | nd | nd | nd | 0.6 |
| C16:1, n-7 | — | 3.2 | 4.4 | 0.2 | 0.5 |
| C18:1, n-9 | — | nd | nd | nd | 4.7 |
| C18:1, n-7 | — | nd | nd | nd | 0.4 |
| C18:1, | — | 9.4 | 11.9 | 59.1 | nd |
| (n-9) + (n-7) + (n-5) | | | | | |
| C20:1, (n-9) + (n-7) | — | 7.6 | 13.9 | 1.7 | nd |
| C22:1, | — | 9.4 | 20.6 | 0.9 | nd |
| (n-11) + (n-9) + (n-7) | | | | | |
| C24:1, n-9 | — | 0.8 | 0.9 | 0.1 | nd |
| C16:2, n-4 | — | 0.3 | 0.3 | <0.1 | nd |
| C16:3, n-4 | — | 0.3 | 0.2 | <0.1 | nd |
| C16:4, n-1 | — | 0.1 | 0.1 | <0.1 | nd |
| C18:2, n-6 | LA | 1.1 | 1.1 | 19.3 | 20.3 |
| C18:3, n-6 | GLA | 0.1 | 0.1 | <0.1 | 1.0 |
| C18:3, n-4 | — | nd | nd | nd | 0.2 |
| C20:2, n-6 | EDA | 0.2 | 0.2 | 0.1 | 3.2 |
| C20:3, n-6 | DGLA | 0.1 | 0.1 | <0.1 | 1.9 |
| C20:4, n-6 | ARA | 0.6 | 0.3 | <0.1 | 0.5 |
| C22:4, n-6 | DTA | <0.1 | <0.1 | <0.1 | nd |
| C18:3, n-3 | ALA | 0.7 | 0.8 | 8.4 | 3.4 |
| C18:4, n-3 | STA | 2 | 1.9 | <0.1 | nd |
| C20:1, n-9 | — | nd | nd | nd | 0.2 |
| C20:1, n-7 | — | nd | nd | nd | 0.6 |
| C20:3, n-3 | ETrA | 0.1 | 0.1 | <0.1 | 0.8 |
| C20:3, n-9 | — | nd | nd | nd | 0.3 |
| C20:4, n-3 | ETA | 0.5 | 0.5 | <0.1 | 0.0 |
| C20:5, n-3 | EPA | 7.4 | 5.2 | 0.1 | 46.8 |
| C21:5, n-3 | — | 0.3 | 0.3 | <0.1 | nd |
| C22:1, n-7 | — | nd | nd | nd | 2.0 |
| C22:1, n-11 | — | nd | nd | nd | 0.5 |
| C22:5, n-3 | DPA | 0.6 | 0.6 | <0.1 | 2.3 |
| C22:6, n-3 | DHA | 10.6 | 5.7 | 0.1 | nd |

*nd = not detected

The EPA:DHA ratios for the fishmeal and fish oil samples were calculated to be 0.7 and 0.9, respectively. In rapeseed oil, the ratio of EPA and DHA was not determined since EPA and DHA levels were below detection limits of the analysis. In the Yarrowia Y4305 F1B1 oil, EPA was very high at 46.8% of total fatty acids, while DHA was not detected.

EPA was determined to be about 15% of the Yarrowia Y4305 F1B1 biomass, since EPA constituted 46.8% of the TFAs and fatty acids (i.e., oil) constituted about 34% of the biomass. Thus, 20% of Yarrowia Y4305 F1B1 biomass in an aquaculture feed composition formulation would provide about 3% of EPA by weight in the aquaculture feed composition.

### Example 2

### Comparison of a Standard Aquaculture Feed Formulation to an Aquaculture Feed Formulation Including Yarrowia lipolytica Y4305 F1B1 Biomass

A standard aquaculture feed formulation was compared to an aquaculture feed formulation containing Yarrowia Y4305 F1B1 biomass.

The Yarrowia Y4305 F1B1 biomass-containing aquaculture feed was formulated using extruded Yarrowia Y4305 F1B1 biomass, prepared as described in the General Methods (supra). Specifically, a portion of the fish oil that is typically present in a standard fish aquaculture feed formulation was replaced with a combination of Yarrowia Y4305 F1B1 biomass and soybean oil. The prepared Yarrowia Y4305 F1B1 biomass, which contained about 34% oil (Example 1), was included as 20% of the total feed on a weight basis. Soybean oil is devoid of EPA and DHA. Fishmeal included in the aquaculture feed formulation was expected to contribute some EPA and DHA. Other standard industry ingredients that provide nutritional benefit in terms of protein, amino acids, fat, carbohydrate, minerals, energy and astaxanthin were added. Components of the Yarrowia Y4305 F1B1 biomass-containing aquaculture feed and the standard aquaculture feed (“control”) are given in Table 4.

The standard aquaculture feed and Yarrowia Y4305 F1B1 biomass-containing aquaculture feed were produced by extrusion using 4.5 mm die opening, giving approximately 5.5 mm pellets after expansion. All aquaculture feed contained 100 ppm Y₂O₃ as an inert marker for digestibility determination.

Aquaculture feed samples were analysed for dry matter [“DM”] (heated at 105° C., until weight was constant), crude protein (N×6.25, Kjeltech Auto System, Tecator, Höganäs, Sweden), ash (heated at 550° C., until weight was constant), energy (adiabatic bomb calorimetry) and astaxanthin (as described by Schierle and Nardi, “Analytical Methods for Vitamins and Carotenoids in Feeds” In: Hoffmann, Keller, Schierle, Schuep, Eds. (1994)) (Table 4).

Additionally, aquaculture feed samples were analysed for lipids (Soxtec System HT 6 and Soxtec System 1047 Hydrolyzing Unit; Tecator, Höganäs, Sweden) (Table 4). In addition to the Soxtec lipid extraction, lipids were extracted by the Folch method (supra) and fatty acid compositions were analysed by GC. The fatty acid profiles of the aquaculture feed samples, wherein the concentration of each fatty acid is presented as a weight percent of total fatty acids [“% TFAs”], is shown in Table 5. EPA is identified as 20:5, n-3, while DHA is identified as 22:6, n-3.

The aquaculture feed samples were also subjected to a water stability test, using a reduced methodology of the test as described by G. Baeverfjord et al. (Aquaculture, 261(4):1335-1345 (2006)). Duplicate samples of each diet (10 g each) were placed in custom made steel-mesh buckets placed inside glass beakers filled with 300 mL distilled water. The beakers were shaken (100/min) in a thermostat-controlled water bath (23° C.) for 120 min, and the remaining amount of dry matter was determined (Table 4).

TABLE 4
Components And Chemical Compositions In A Standard Aquaculture
Feed Formulation And In Aquaculture Feed Formulation Including
Yarrowia Y4305 F1B1 Biomass

| | | Yarrowia Y4305 |
|---|---|---|
| Component, % | Standard Feed | F1B1 Feed |
| Fish meal | 20.2 | 20.2 |
| Sunflower meal, extracted | 11.7 | 3.6 |
| Hydrolyzed feather meal | 11.0 | 13.0 |
| Corn gluten | 9.0 | 8.9 |
| Yarrowia Y4305 F1B1 biomass | 0 | 20.0 |
| Fish oil | 26.0 | 0 |
| Soybean oil | 0 | 21.0 |
| Soybean meal | 4.0 | 2.0 |
| Wheat | 13.5 | 6.7 |
| Monocalcium phosphate | 1.4 | 1.4 |
| Vitamin mix | 2.0 | 2.0 |
| Mineral mix | 0.4 | 0.4 |
| L-Lysine HCl | 0.5 | 0.5 |
| DL-Methionine | 0.2 | 0.2 |
| Carophyll Pink (10% | 0.055 | 0.055 |
| astaxanthin) | | |
| Yttrium oxide | 0.01 | 0.01 |

Chemical composition, %

| | | |
|---|---|---|
| Dry matter | 93.6 | 94.1 |
| Crude fat* | 31.1 | 31.3 |
| Crude protein, N × 6.25 | 37.5 | 38.7 |
| Ash | 5.2 | 5.9 |
| Energy, MJ/kg | 24.5 | 24.7 |
| Astaxanthin, mg/kg | 54.2 | 58.6 |
| Yttrium, % | 0.010 | 0.010 |

Minerals

| | | |
|---|---|---|
| P, mg/kg | 10471 | 10775 |
| Ca, mg/kg | 8169 | 8349 |
| Na, mg/kg | 2977 | 2999 |
| Mg, mg/kg | 2519 | 2048 |
| Zn, mg/kg | 160 | 149 |
| Fe, mg/kg | 195 | 201 |
| Cu, mg/kg | 13 | 12 |

*See Table 5 for lipid composition of crude fat.

TABLE 5
Lipid Composition In A Standard Aquaculture Feed Formulation And In
Aquaculture Feed Formulation Including Yarrowia Y4305 F1B1 Biomass

| | | Yarrowia |
|---|---|---|
| | Standard | Y4305 |
| Fatty acid | Feed | F1B1 Feed |
| 14:0 | 7.4 | 0.5 |
| 14:1, n-5 | 0.4 | *nd |
| 15:0 | 0.3 | 0.1 |
| 16:0 | 12.3 | 10.0 |
| 16:1, n-5 | 0.1 | 0.1 |
| 16:1, n-7 | 4.1 | 0.5 |
| 16:1, n-9 | 0.2 | 0.1 |
| 16:2, n-6 | 0.3 | 0.1 |
| 17:0 | 0.5 | 0.1 |
| 18:0 | 1.4 | 3.4 |
| 18:1, n-11 | 0.7 | 0.1 |
| 18:1, n-7 | 1.6 | 1.1 |
| 18:1, n-9 | 11.0 | 17.1 |
| 18:2, n-6 | 4.5 | 43.8 |
| 18:3, n-3 | 1.0 | 5.6 |
| 18:3, n-4 | 0.1 | 0.2 |
| 18:3, n-6 | 0.1 | 0.1 |
| 18:4, n-3 | 0.2 | 0.1 |
| 20:0 | 0.2 | 0.3 |
| 20:1, n-11 | 1.8 | 0.2 |
| 20:1, n-9 | 14.1 | 0.8 |
| 20:2, n-6 | 0.2 | 0.7 |
| 20:3, n-3 | 0.2 | 0.2 |
| 20:3, n-6 | 0.0 | 0.4 |
| 20:4, n-3 | 0.0 | 0.1 |
| 20:4, n-6 | 0.2 | 0.1 |
| 20:5, n-3 | 5.1 | 9.1 |
| 22:0 | 0.1 | 0.5 |
| 22:1, n-11 | 21.5 | 1.1 |
| 22:1, n-7 | 0.4 | 0.4 |
| 22:5, n-3 | 0.6 | 0.5 |
| 22:6, n-3 | 5.2 | 1.0 |
| 24:0 | 0.2 | 0.3 |
| EPA:DHA | 0.98:1 | 9:1 |
| Ratio | | |

*nd = not detected.

Although the EPA:DHA ratio of the aquaculture feed formulations are dramatically different (i.e., 0.98:1 for the standard aquaculture feed formation versus 9:1 for the aquaculture feed formulation including Yarrowia Y4305 F1B1 biomass, wherein the biomass was included as 20% of the total aquaculture feed on a weight basis), the concentration of EPA plus DHA as a weight percent of total fatty acids [“EPA+DHA % TFAs”] in both aquaculture feed formulations was similar: 10.3 EPA+DHA % TFAs for the standard feed formation versus 10.1 EPA+DHA % TFAs for the aquaculture feed formulation including Yarrowia Y4305 F1B1 biomass.

The total amount of EPA plus DHA, measured as a weight percent of each aquaculture feed formulation (i.e., “EPA+DHA %”), can also be calculated by multiplying (EPA+DHA % TFAs)*(total fat in the aquaculture feed formulation). Thus, the standard aquaculture feed formulation contained 3.19% EPA+DHA (i.e., [10.3 EPA+DHA % TFAs]*0.31), while the aquaculture feed formulation including Yarrowia Y4305 F1B1 biomass contained 3.13% EPA+DHA (i.e., [10.1 EPA+DHA % TFAs]*0.31).

### Example 3

### Comparison of Standard Feed Formulations to Feed Formulations Including Variable Percentages of Yarrowia lipolytica Y4305 Biomass

Two different standard aquaculture feed formulations, comprising rapeseed oil or a combination of rapeseed and fish oil, were compared to three different aquaculture feed formulations containing Yarrowia lipolytica Y4305 biomass.

As described in the General Methods, while Y. lipolytica strain Y4305 F1B1 (used in Example 2) contains approximately 28-38% fat (i.e., measured as average lipid content [“TFAs % DCW”]) and approximately 15% EPA (i.e., measured EPA content as a percent of the dry cell weight [“EPA % DCW”]), Y. lipolytica strain Y4305 contains approximately 20-28 TFAs % DCW and approximately 13 EPA % DCW/. Aquaculture feed formulations comprising the Yarrowia Y4305 biomass, as described in the present Example, were therefore expected to have different compositions than the aquaculture feed formulations prepared in Example 2, comprising the Yarrowia Y4305 F1B1 biomass. Additionally, the present Example compares aquaculture feed formulation components and chemical/lipid compositions when the Yarrowia Y4305 biomass was included as 10%, 20% or 30% of the total aquaculture feed on a weight basis, i.e., designated as “Yarrowia Y4305 Feed-10%”, “Yarrowia Y4305 Feed-20%” and “Yarrowia Y4305 Feed-30%”.

Salmon aquaculture feeds commonly contain either 100% fish oil or mixtures of vegetable oils and fish oils to achieve sufficient caloric value and total omega-3 fatty acid content in the feed formulation. Thus, two standard aquaculture feeds (“control”) were prepared in the present Example, the first comprising 100% rapeseed oil and designated as “Standard Feed-Rapeseed oil”, and the second comprising a mixture of rapeseed oil and fish oil (1.7:1 ratio) and designated as “Standard Feed-Fish oil”.

In contrast, each of the aquaculture feed formulations containing Yarrowia lipolytica Y4305 biomass were prepared with a mixture of rapeseed oil and Yarrowia Y4305 biomass.

Yarrowia Y4305 biomass-containing aquaculture feeds were formulated using extruded Yarrowia Y4305 biomass, prepared as described in the General Methods (supra). As mentioned above, the prepared Yarrowia Y4305 biomass was included as either 10%, 20% or 30% of the total feed on a weight basis. Rapeseed oil is effectively devoid of EPA and DHA. Fishmeal included in the aquaculture feed formulation was expected to contribute some EPA and DHA. Other standard industry ingredients of commercial fish aquaculture feeds that provide nutritional benefit in terms of protein, amino acids, fat, carbohydrate, minerals, energy and astaxanthin were added, as in Example 2 and the final formulation was similarly extruded. The other aquaculture feed components were balanced across the aquaculture feeds in order to provide identical levels of protein, fat carbohydrate and energy. Components of the three Yarrowia Y4305 biomass-containing aquaculture feeds and the two standard aquaculture feeds (“control”) are given in Table 6.

Following extrusion of the two standard aquaculture feeds and three Yarrowia Y4305 biomass-containing aquaculture feeds, aquaculture feed samples were analysed for dry matter [“DM”], crude protein, ash, energy, astaxanthin and lipids (both by Soxhlet lipid extraction and by the Folch method) and subjected to a water stability test, according to the methodologies of Example 2. This data is summarized in Table 6, while the fatty acid profiles of the feed samples are shown in Table 7. The concentration of each fatty acid is presented as a weight percent of total fatty acids [“% TFAs”]; EPA is identified as 20:5, n-3, while DHA is identified as 22:6, n-3.

TABLE 6
Components And Chemical Compositions In Two Alternate Standard
Aquaculture Feed Formulations And In Three Alternate Aquaculture Feed
Formulations Including Yarrowia Y4305 Biomass

| Standard | Yarrowia | Yarrowia | Yarrowia | |
|---|---|---|---|---|
| Feed- | Y4305 | Y4305 | Y4305 | Standard |
| Rapeseed | Feed- | Feed- | Feed- | Feed- |
| oil | 10% | 20% | 30% | Fish oil |

Formulation, %

| | | | | | |
|---|---|---|---|---|---|
| LT fish meal | 48.9 | 46.1 | 43.2 | 40.3 | 48.9 |
| Wheat gluten | 10 | 10 | 10 | 10 | 10 |
| Yarrowia | 0 | 10 | 20 | 30 | 0 |
| Y4305 | | | | | |
| biomass | | | | | |
| Fish oil | 0 | 0 | 0 | 0 | 7.34 |
| Rapeseed oil | 19.9 | 18.3 | 16.7 | 15.1 | 12.56 |
| Wheat | 18.7 | 13.1 | 7.6 | 2.1 | 18.7 |
| Vitamin mix | 2 | 2 | 2 | 2 | 2 |
| Mineral mix | 0.4 | 0.4 | 0.4 | 0.4 | 0.4 |
| Carophyll | 0.055 | 0.055 | 0.055 | 0.055 | 0.055 |
| Pink (10% | | | | | |
| astaxanthin) | | | | | |
| Yttrium | 0.01 | 0.01 | 0.01 | 0.01 | 0.01 |
| oxide | | | | | |

Chemical composition, %

| | | | | | |
|---|---|---|---|---|---|
| Dry matter | 93.6 | 91.3 | 92.7 | 92.8 | 93.7 |
| Crude fat* | 25.3 | 24.8 | 24.7 | 23.8 | 25.8 |
| Crude | 46.5 | 43.9 | 45.3 | 44.9 | 45.1 |
| protein, | | | | | |
| N x 6.25 | | | | | |
| Ash | 7.9 | 7.5 | 7.3 | 6.9 | 8.0 |
| Energy, | 23.2 | 22.8 | 23.1 | 23.1 | 23.5 |
| MJ/kg | | | | | |
| Astaxanthin, | 52.7 | 48.8 | 49.2 | 47.5 | 56.1 |
| mg/kg | | | | | |
| Yttrium, | 98 | 98 | 102 | 99 | 99 |
| mg/kg | | | | | |

Minerals

| | | | | | |
|---|---|---|---|---|---|
| P, % | 1.18 | 1.12 | 1.04 | 1.02 | 1.16 |
| Ca, % | 1.46 | 1.36 | 1.28 | 1.17 | 1.39 |
| Mg, mg/kg | 1839 | 1784 | 1597 | 1852 | 1818 |
| Na, mg/kg | 7214 | 5412 | 5468 | 6033 | 5892 |
| Fe, mg/kg | 108 | 127 | 147 | 144 | 112 |
| Mn, mg/kg | 32 | 32 | 30 | 39 | 45 |
| Zn, mg/kg | 148 | 143 | 143 | 146 | 160 |
| Cu, mg/kg | 9.3 | 10.0 | 10.9 | 11.3 | 9.8 |

*See Table 7 for lipid composition of crude fat.

TABLE 7
Lipid Composition In Two Alternate Standard Aquaculture Feed
Formulations And In Three Alternate Aquaculture Feed Formulations
Including Yarrowia Y4305 F1B1 Biomass

| | Standard | Yarrowia | Yarrowia | Yarrowia | |
|---|---|---|---|---|---|
| Fatty acid | Feed- | Y4305 | Y4305 | Y4305 | Standard |
| composition, | Rapeseed | Feed- | Feed- | Feed- | Feed- |
| % | oil | 10% | 20% | 30% | Fish oil |
| 12:0 | 0.1 | *nd | *nd | *nd | *nd |
| 14:0 | 1.0 | 0.8 | 0.8 | 0.8 | 2.4 |
| 14:1, n-5 | *nd | *nd | *nd | *nd | 0.1 |
| 15:0 | *nd | 0.1 | 0.1 | 0.1 | 0.2 |
| 16:0 | 6.8 | 6.6 | 6.9 | 7.3 | 8.0 |
| 16:1, n-5 | 0.1 | nd | 0.1 | 0.1 | 0.1 |
| 16:1, n-7 | 1.1 | 1.0 | 1.0 | 1.0 | 2.0 |
| 16:1, n-9 | 0.1 | 0.1 | *nd | 0.1 | 0.1 |
| 16:2, n-3 | 0.1 | 0.1 | 0.1 | 0.1 | 0.1 |
| 16:3, n-4 | 0.1 | 0.1 | 0.0 | 0.0 | 0.1 |
| 17:0 | 0.1 | 0.1 | 0.1 | 0.2 | 0.2 |
| 17:1, n-7 | 0.1 | 0.1 | 0.1 | 0.1 | 0.1 |
| 18:0 | 1.9 | 2.1 | 2.4 | 2.7 | 1.8 |
| 18:1, n-11 | 0.1 | 0.1 | 0.1 | 0.1 | 0.3 |
| 18:1, n-7 | 2.9 | 2.7 | 2.6 | 2.5 | 2.6 |
| 18:1, n-9 | 46.7 | 46.0 | 43.5 | 40.6 | 37.4 |
| 18:2, n-6 | 17.5 | 18.1 | 18.2 | 18.3 | 13.8 |
| 18:3, n-3 | 7.1 | 7.1 | 6.8 | 6.4 | 5.5 |
| 18:3, n-4 | 0.1 | 0.1 | 0.1 | 0.1 | 0.1 |
| 18:3, n-6 | 0.1 | 0.1 | 0.1 | 0.1 | 0.1 |
| 20:0 | 0.5 | 0.5 | 0.6 | 0.6 | 0.4 |
| 20:1, n-11 | 0.5 | 0.5 | 0.5 | 0.5 | 1.0 |
| 20:1, n-7 | 0.1 | 0.1 | 0.1 | 0.1 | 0.2 |
| 20:1, n-9 | 3.2 | 2.8 | 2.7 | 2.6 | 5.6 |
| 20:2, n-6 | 0.1 | 0.3 | 0.4 | 0.6 | 0.2 |
| 20:3, n-3 | 0.1 | 0.1 | 0.1 | 0.1 | *nd |
| 20:3, n-6 | *nd | 0.2 | 0.4 | 0.6 | *nd |
| 20:4, n-3 | 0.3 | 0.2 | 0.2 | 0.2 | 0.6 |
| 20:4, n-6 | 0.1 | 0.1 | 0.1 | 0.2 | 0.2 |
| 20:5, n-3 | 1.8 | 3.0 | 4.7 | 6.5 | 3.1 |
| 22:0 | 0.3 | 0.3 | 0.3 | 0.4 | 0.2 |
| 22:1, n-11 | 2.4 | 2.0 | 1.9 | 1.9 | 6.9 |
| 22:1, n-7 | 0.1 | 0.3 | 0.5 | 0.7 | 0.2 |
| 22:1, n-9 | 0.9 | 0.9 | 0.8 | 0.8 | 1.1 |
| 22:4, n-6 | 0.3 | 0.2 | 0.3 | 0.5 | 0.1 |
| 22:5, n-3 | 0.2 | 0.2 | 0.2 | 0.3 | 0.3 |
| 22:6, n-3 | 2.4 | 2.2 | 2.1 | 2.1 | 3.6 |
| 24:1, n-9 | *nd | 0.3 | 0.2 | 0.2 | 0.4 |
| EPA:DHA | 0.75:1 | 1.36:1 | 2.23:1 | 3.1:1 | 0.86:1 |
| Ratio | | | | | |

*nd = not detected

As seen in Table 7, the EPA:DHA ratio of the aquaculture feed formulations are dramatically different. Each of the aquaculture feed formulations including Yarrowia Y4305 biomass as a substitute for fish oil had a higher EPA:DHA ratio than either of the standard aquaculture feeds comprising 100% rapeseed oil or the mixture of rapeseed oil and fish oil (i.e., 1.36:1, 2.23:1 and 3.1:1, respectively, versus 0.75:1 and 0.86:1, respectively). Notably, the Yarrowia Y4305 Aquaculture Feed-20% formulation and the Yarrowia Y4305 Aquaculture Feed-30% formulation both had EPA:DHA ratios greater than 2:1.

The EPA+DHA % TFAs in each of the aquaculture feed formulations was determined, as described in Example 2. Specifically, the Standard Feed-Rapeseed Oil formulation had 4.2 EPA+DHA % TFAs or 1.06 EPA+DHA % in the feed, while the Standard Feed-Fish Oil formulation had 6.7 EPA+DHA % TFAs or 1.73 EPA+DHA % in the feed. The Yarrowia Y4305 Feed-10% formulation had 5.2 EPA+DHA % TFAs or 1.29 EPA+DHA % in the feed, the Yarrowia Y4305 Feed-20% formulation had 6.8 EPA+DHA % TFAs or 1.68 EPA+DHA % in the feed and the Yarrowia Y4305 Feed-30% formulation had 8.6 EPA+DHA % TFAs or 2.05 EPA+DHA % in the feed.

### Example 4

### Comparison of EPA:DHA Ratios in Alternate Aquaculture Feed Formulations Including Variable Percentages of Yarrowia lipolytica Y4305 F1B1 Biomass

A multi-variant analysis was performed to analyze the total EPA content, total DHA content and ratio of EPA:DHA in a variety of different model aquaculture feed formulations, wherein the aquaculture feed formulations comprised: a) either anchovy oil or menhaden oil, included as 0%, 2%, 5%, 10% or 20% of the total feed on a weight basis; and, b) Yarrowia lipolytica Y4305 F1B1 biomass, included as 10%, 20% or 30% of the total feed on a weight basis.

As previously noted, salmon aquaculture feeds commonly contain either 100% fish oil or mixtures of vegetable oils and fish oils to achieve sufficient caloric value and total omega-3 fatty acid content in the feed formulation. The fish oil can be purified from a variety of different fish species, such as anchovy, capelin, menhaden, herring and cod, and each oil has its own unique fatty acid lipid profile. For example, anchovy oil was assumed herein to comprise 17 EPA % TFAs and 8.8 DHA % TFAs, producing a EPA:DHA ratio of 1.93:1. In contrast, menhaden oil was assumed herein to comprise 11 EPA % TFAs and 9.1 DHA % TFAs, producing a EPA:DHA ratio of 1.21:1.

For the purposes of the calculations herein, the Yarrowia lipolytica Y4305 F1B1 biomass was assumed to comprise 15 EPA % DCW, with no DHA, and biomass of strain Y4305 F1B1 typically contains an average lipid content of about 28-32 TFAs % DCW (see General Methods). Both the concentration of EPA as a percent of the total fatty acids [“EPA TFAs”] and total lipid content [“TFAs % DCW”] affect the cellular content of EPA as a percent of the dry cell weight [“EPA % DCW”]. That is, EPA DCW is calculated as: (EPA % TFAs)*(TFAs % DCW)]/100. Based on the assumptions provided above with respect to TFAs % DCW and EPA DCW, the EPA % TFAs for Yarrowia lipolytica Y4305 F1B1 biomass was calculated to be 50 and DHA % TFAs was zero.

Finally, it was necessary to calculate the total EPA content and total DHA content in the fish meal provided in each aquaculture feed formulation. It was assumed that the aquaculture feed formulations containing menhaden oil also included menhaden fish meal, while the aquaculture feed formulations containing anchovy oil also included anchovy fish meal. The following set of assumptions were utilized in the EPA and DHA calculations:

### For Anchovy Fish Meal:

1. Anchovy fish meal will be included in the final aquaculture feed formulation as 25% of the total feed on a weight basis;
2. Anchovy fish meal is assumed to have a total fat content of 6%;
3. One-quarter (25%) of the total fat content is assumed to be EPA and DHA;
4. For every 100 g of aquaculture feed formulation produced, 1.5% of the total aquaculture feed formulation on a weight basis is total fat content derived from anchovy fish meal (i.e., 0.25*6).
5. Since 25% of total fat content derived from anchovy fish meal in the aquaculture feed formulation is EPA and DHA, it is assumed that 0.375% of the total aquaculture feed formulation on a weight basis is EPA and DHA derived from the anchovy fish meal.
6. Of the Total EPA+DHA in Anchovy oil, 72% is EPA and 28% is DHA.
7. Thus, for every 100 g of aquaculture feed formulation produced, 0.27% is EPA derived from the anchovy fish meal (i.e., 0.375%*0.72) and 0.1% is DHA derived from the anchovy fish meal (i.e., 0.375%*0.28).

### For Menhaden Fish Meal:

1. Menhaden fish meal will be included in the final aquaculture feed formulation as 25% of the total feed on a weight basis;
2. Menhaden fish meal is assumed to have a total fat content of 6%;
3. One-fifth (20%) of the total fat content is assumed to be EPA and DHA;
4. For every 100 g of aquaculture feed formulation produced, 1.5% of the total aquaculture feed formulation on a weight basis is total fat content derived from menhaden fish meal (i.e., 0.25*6).
5. Since 20% of total fat content derived from menhaden fish meal in the feed formulation is EPA and DHA, it is assumed that 0.30% of the total aquaculture feed formulation on a weight basis is EPA and DHA derived from the menhaden fish meal.
6. Of the Total EPA+DHA in Menhaden oil, 55% is EPA and 45% is DHA.
7. Thus, for every 100 g of aquaculture feed formulation produced, 0.165% is EPA derived from the menhaden fish meal (i.e., 0.30%*0.55) and 0.135% is DHA derived from the menhaden fish meal (i.e., 0.30%*0.45).

Based on the assumptions above, it was possible to calculate the total EPA content, total DHA content and ratio of EPA:DHA in five different aquaculture feed formulations comprising anchovy oil (included as 0%, 2%, 5%, 10% or 20% of the total feed on a weight basis) and Yarrowia lipolytica Y4305 F1B1 biomass (included as 10%, 20% or 30% of the total aquaculture feed on a weight basis) (Table 8). Similarly, total EPA content, total DHA content and ratio of EPA:DHA in five different aquaculture feed formulations comprising menhaden oil (included as 0%, 2%, 5%, 10% or 20% of the total aquaculture feed on a weight basis) and Yarrowia lipolytica Y4305 F1B1 biomass (included as 10%, 20% or 30% of the total aquaculture feed on a weight basis) were calculated (Table 9).

TABLE 8
EPA And DHA Content In Aquaculture Feed Formulations Comprising Variable
Concentrations Of Yarrowia Y4305 F1B1 Biomass (10%, 20% And 30%)
And Variable Concentrations Of Anchovy Oil (0%, 2%, 5%, 10% And 20%)

| | % Yarrowia* | | | | | | | |
|---|---|---|---|---|---|---|---|---|
| | 30 | 30 | 30 | 30 | 30 | 20 | 20 | 20 |
| % EPA in | 4.50 | 4.50 | 4.50 | 4.50 | 4.50 | 3.00 | 3.00 | 3.00 |
| Yarrowia* | | | | | | | | |
| % DHA in | 0.00 | 0.00 | 0.00 | 0.00 | 0.00 | 0.00 | 0.00 | 0.00 |
| Yarrowia* | | | | | | | | |
| % anchovy oil | 0.00 | 2.00 | 5.00 | 10.00 | 20.00 | 0.00 | 2.00 | 5.00 |
| % EPA in | 0.00 | 0.34 | 0.84 | 1.68 | 3.35 | 0.00 | 0.34 | 0.84 |
| anchovy oil | | | | | | | | |
| % DHA in | 0.00 | 0.18 | 0.45 | 0.90 | 1.80 | 0.00 | 0.18 | 0.45 |
| anchovy oil | | | | | | | | |
| % Fish meal | 25.00 | 25.00 | 25.00 | 25.00 | 25.00 | 25.00 | 25.00 | 25.00 |
| % EPA in | 0.27 | 0.27 | 0.27 | 0.27 | 0.27 | 0.27 | 0.27 | 0.27 |
| Fish meal | | | | | | | | |
| % DHA in | 0.10 | 0.10 | 0.10 | 0.10 | 0.10 | 0.10 | 0.10 | 0.10 |
| Fish meal | | | | | | | | |
| Total EPA in | 4.77 | 5.11 | 5.61 | 6.45 | 8.12 | 3.27 | 3.61 | 4.11 |
| Formulation | | | | | | | | |
| Total DHA in | 0.10 | 0.28 | 0.55 | 1.00 | 1.90 | 0.10 | 0.28 | 0.55 |
| Formulation | | | | | | | | |
| Total EPA + | 4.87 | 5.39 | 6.16 | 7.45 | 10.02 | 3.37 | 3.89 | 4.66 |
| DHA in | | | | | | | | |
| Formulation | | | | | | | | |
| EPA:DHA | 47.70:1 | 18.25:1 | 10.20:1 | 6.45:1 | 4.27:1 | 32.70:1 | 12.89:1 | 7.47:1 |
| Ratio | | | | | | | | |

| | % Yarrowia* | | | | | | |
|---|---|---|---|---|---|---|---|
| | 20 | 20 | 10 | 10 | 10 | 10 | 10 |
| % EPA in | 3.00 | 3.00 | 1.50 | 1.50 | 1.50 | 1.50 | 1.50 |
| Yarrowia* | | | | | | | |
| % DHA in | 0.00 | 0.00 | 0.00 | 0.00 | 0.00 | 0.00 | 0.00 |
| Yarrowia* | | | | | | | |
| % anchovy oil | 10.00 | 20.00 | 0.00 | 2.00 | 5.00 | 10.00 | 20.00 |
| % EPA in | 1.68 | 3.35 | 0.00 | 0.34 | 0.84 | 1.68 | 3.35 |
| anchovy oil | | | | | | | |
| % DHA in | 0.90 | 1.80 | 0.00 | 0.18 | 0.45 | 0.90 | 1.80 |
| anchovy oil | | | | | | | |
| % Fish meal | 25.00 | 25.00 | 25.00 | 25.00 | 25.00 | 25.00 | 25.00 |
| % EPA in | 0.27 | 0.27 | 0.27 | 0.27 | 0.27 | 0.27 | 0.27 |
| Fish meal | | | | | | | |
| % DHA in | 0.10 | 0.10 | 0.10 | 0.10 | 0.10 | 0.10 | 0.10 |
| Fish meal | | | | | | | |
| Total EPA in | 4.95 | 6.62 | 1.77 | 2.11 | 2.61 | 3.45 | 5.12 |
| Formulation | | | | | | | |
| Total DHA in | 1.00 | 1.90 | 0.10 | 0.28 | 0.55 | 1.00 | 1.90 |
| Formulation | | | | | | | |
| Total EPA + | 5.95 | 8.52 | 1.87 | 2.39 | 3.16 | 4.45 | 7.02 |
| DHA in | | | | | | | |
| Formulation | | | | | | | |
| EPA:DHA | 4.95:1 | 3.48:1 | 17.70:1 | 7.54:1 | 4.75:1 | 3.45:1 | 2.69:1 |
| Ratio | | | | | | | |

*Yarrowia refers to Yarrowia lipolytica strain Y4305 F1B1 biomass.

TABLE 9
EPA And DHA Content In Aquaculture Feed Formulations Comprising Variable
Concentrations Of Yarrowia Y4305 F1B1 Biomass (10%, 20% And 30%)
And Variable Concentrations Of Menhaden Oil (0%, 2%, 5%, 10% And 20%)

| | % Yarrowia* | | | | | | | |
|---|---|---|---|---|---|---|---|---|
| | 30 | 30 | 30 | 30 | 30 | 20 | 20 | 20 |
| % EPA in | 4.50 | 4.50 | 4.50 | 4.50 | 4.50 | 3.00 | 3.00 | 3.00 |
| Yarrowia* | | | | | | | | |
| % DHA in | 0.00 | 0.00 | 0.00 | 0.00 | 0.00 | 0.00 | 0.00 | 0.00 |
| Yarrowia* | | | | | | | | |
| % menhaden | 0.00 | 2.00 | 5.00 | 10.00 | 20.00 | 0.00 | 2.00 | 5.00 |
| oil | | | | | | | | |
| % EPA in | 0.00 | 0.22 | 0.54 | 1.08 | 2.16 | 0.00 | 0.22 | 0.54 |
| menhaden oil | | | | | | | | |
| % DHA in | 0.00 | 0.18 | 0.46 | 0.92 | 1.84 | 0.00 | 0.18 | 0.46 |
| menhaden oil | | | | | | | | |
| % Fish meal | 25.00 | 25.00 | 25.00 | 25.00 | 25.00 | 25.00 | 25.00 | 25.00 |
| % EPA in | 0.17 | 0.17 | 0.17 | 0.17 | 0.17 | 0.17 | 0.17 | 0.17 |
| Fish meal | | | | | | | | |
| % DHA in | 0.13 | 0.13 | 0.13 | 0.13 | 0.13 | 0.13 | 0.13 | 0.13 |
| Fish meal | | | | | | | | |
| Total EPA in | 4.67 | 4.89 | 5.21 | 5.75 | 6.83 | 3.17 | 3.39 | 3.71 |
| Formulation | | | | | | | | |
| Total DHA in | 0.13 | 0.31 | 0.59 | 1.05 | 1.97 | 0.13 | 0.31 | 0.59 |
| Formulation | | | | | | | | |
| Total EPA + | 4.80 | 5.20 | 5.80 | 6.80 | 8.80 | 3.30 | 3.70 | 4.30 |
| DHA in | | | | | | | | |
| Formulation | | | | | | | | |
| EPA:DHA | 35.92:1 | 15.77:1 | 8.83:1 | 5.48:1 | 3.47:1 | 24.38:1 | 10.94:1 | 6.29:1 |
| Ratio | | | | | | | | |

| | % Yarrowia* | | | | | | |
|---|---|---|---|---|---|---|---|
| | 20 | 20 | 10 | 10 | 10 | 10 | 10 |
| % EPA in | 3.00 | 3.00 | 1.50 | 1.50 | 1.50 | 1.50 | 1.50 |
| Yarrowia* | | | | | | | |
| % DHA in | 0.00 | 0.00 | 0.00 | 0.00 | 0.00 | 0.00 | 0.00 |
| Yarrowia* | | | | | | | |
| % menhaden | 10.00 | 20.00 | 0.00 | 2.00 | 5.00 | 10.00 | 20.00 |
| oil | | | | | | | |
| % EPA in | 1.08 | 2.16 | 0.00 | 0.22 | 0.54 | 1.08 | 2.16 |
| menhaden oil | | | | | | | |
| % DHA in | 0.92 | 1.84 | 0.00 | 0.18 | 0.46 | 0.92 | 1.84 |
| menhaden oil | | | | | | | |
| % Fish meal | 25.00 | 25.00 | 25.00 | 25.00 | 25.00 | 25.00 | 25.00 |
| % EPA in | 0.17 | 0.17 | 0.17 | 0.17 | 0.17 | 0.17 | 0.17 |
| Fish meal | | | | | | | |
| % DHA in | 0.13 | 0.13 | 0.13 | 0.13 | 0.13 | 0.13 | 0.13 |
| Fish meal | | | | | | | |
| Total EPA in | 4.25 | 5.33 | 1.67 | 1.89 | 2.21 | 2.75 | 3.83 |
| Formulation | | | | | | | |
| Total DHA in | 1.05 | 1.97 | 0.13 | 0.31 | 0.59 | 1.05 | 1.97 |
| Formulation | | | | | | | |
| Total EPA + | 5.30 | 7.30 | 1.80 | 2.20 | 2.80 | 3.80 | 5.80 |
| DHA in | | | | | | | |
| Formulation | | | | | | | |
| EPA:DHA | 4.05:1 | 2.71:1 | 12.85:1 | 6.10:1 | 3.75:1 | 2.62:1 | 1.94:1 |
| Ratio | | | | | | | |

*Yarrowia refers to Yarrowia lipolytica strain Y4305 F1B1 biomass.

EPA:DHA ratios in the aquaculture feed composition that are greater than 2:1 were obtained for all combinations of fish oil and Yarrowia lipolytica Y4305 F1B1 biomass, except in the one case of the aquaculture feed composition containing 20% menhaden oil in combination with 10% Yarrowia lipolytica Y4305 F1B1 biomass.

### Example 5

### Aquaculture of Salmon Using a Standard Aquaculture Feed Formulation and a Feed Formulation Including Yarrowia lipolytica Y4305 F1B1 Biomass

The efficacies of the aquaculture feed formulations of Example 2 were compared in the present Example when used in salmon aquaculture. Specifically, the effects of the standard aquaculture feed formulation and the aquaculture feed formulation including 20% Yarrowia Y4305 F1B1 biomass were compared with respect to total fish biomass, biomass increase, average body weight, individual weight gain, pigmentation, dry matter content, crude protein content, total lipid content and fatty acid profile.

The experiment was carried out in 15 indoor tanks at Nofima Marine, Sunndalsøra, Norway. Each tank (2 m² surface area, 0.6 m water depth) was supplied with seawater (i.e., approximately 33 ppt salinity, at ambient temperature) and stocked with 42 Atlantic salmon (Salmo salar) of the SalmoBreed strain, mean weight approximately 495 g. Prior to the experiment, the fish had been stocked in larger groups in 1 m² tanks with similar conditions. The fish were kept under constant photoperiod during the experimental period.

Triplicate tanks of fish were fed by automatic feeders, aiming at an overfeeding of about 20% to allow maximum feed intake by the fish. The fish were counted and bulk weighed at the start of the experiment [“Day 0”], and bulk weighed after 4 weeks [“Day 28”] of feeding the experimental diets. Any dead fish were removed from the tanks and weighed immediately.

At the start of the experiment, fillets were sampled from 3 tanks at 10 fish per tank. This analysis was also performed after 8 and 16 weeks [“Day 53” and “Day 112”, respectively] (using 8 fish per tank at each time period). The color was first measured in the fresh fillets by a Minolta Chromameter, providing L*a*b values (wherein “L” is a measure of lightness, “a” is a measure of red color and “b” is a measure of yellow color). The fillets were frozen for subsequent analyses of carotenoids, as described by Bjerkeng et al. (Aquaculture, 157(1-2):63-82 (1997)). Fillets were also analyzed for dry matter content, crude protein content, total lipid content and fatty acids. Methods for analyses of fillet, whole body homogenates and faeces were as described in Example 2 for analyses of feeds.

Additionally, whole fish were sampled (10 fish per tank) at the start of the experiment, and homogenized pooled samples of fish were frozen. After 16 weeks an additional 5 fish per tank were sampled and homogenized pooled samples of fish were frozen. All whole body homogenates were analyzed for dry matter content, crude protein content, total lipid content and fatty acids.

Results of feeding trials are shown below in Table 10 and Table 11, with all data reported as the mean, plus or minus standard error of the mean [“±S.E.M”]. Specifically, Table 10 shows total fish biomass (at Days 0, 28, 53 and 112), biomass [“BM”] increases (between Days 0-28, Days 29-53 and Days 54-112), average body weight (at Days 0, 28, 53 and 112) and individual weight gain (between Days 0-28, Days 29-53 and Days 54-112). No unusual mortality was observed during the 112 day trial, evidenced by comparable weight gains (measured as both biomass per tank of fish and measured as weight per fish) for fish fed either the standard feed formulation or the feed formulation including 20% Yarrowia Y4305 F1B1 biomass.

TABLE 10
Total Tank Biomass And Fish Weight In Groups Of Fish Fed A Standard
Aquaculture Feed Formulation And An Aquaculture Feed Formulation
Including Yarrowia lipolytica Y4305 F1B1 Biomass

| | |
|---|---|
| | Yarrowia |
| Standard Feed | Y4305 F1B1 Feed |

Biomass, kg/tank

| | | |
|---|---|---|
| Day 0 | 20788 ± 19 | 20801 ± 17 |
| Day 28 | 23240 ± 440 | 24763 ± 168 |
| Day 53 | 27997 ± 490 | 29132 ± 392 |
| Day 112 | 34342 ± 839 | 35078 ± 462 |
| BM Increase, 0-28 days | 2452 ± 445 | 3963 ± 180 |
| BM Increase, 29-53 days | 4757 ± 78 | 4369 ± 225 |
| BM Increase, 54-112 days | 11869 ± 520 | 11241 ± 194 |

Average body weight, g

| | | |
|---|---|---|
| Day 0 | 495.0 ± 0.6 | 495.3 ± 0.7 |
| Day 28 | 553.3 ± 10.7 | 589.7 ± 3.8 |
| Day 53 | 671.7 ± 6.4 | 688.0 ± 7.8 |
| Day 112 | 1021 ± 32 | 1032 ± 14 |
| Weight gain, 0-28 days | 58.3 ± 10.7 | 94.3 ± 4.3 |
| Weight gain, 29-53 days | 118.3 ± 4.7 | 98.3 ± 5.3 |
| Weight gain, 54-112 days | 349.0 ± 28.6 | 343.5 ± 12.2 |

Table 11 reports the overall composition of the sample fish fillets (in terms of total protein content, dry matter content, fat content, pigmentation and fatty acid profile), wherein the fillets were sampled from fish that were fed either the standard aquaculture feed formulation or the aquaculture feed formulation including 20% Yarrowia Y4305 F1B1 biomass. All data is with respect to grams per 100 grams wet weight of the fish fillet. Values are reported at Day 0 and at Day 112. EPA is identified as 20:5, n-3, while DHA is identified as 22:6, n-3.

TABLE 11
Fatty Acid Composition And Carotenoid Content Of Salmon Fed Either A
Standard Aquaculture Feed Formulation Or An Aquaculture Feed
Formulation Including Yarrowia lipolytica Y4305 F1B1 Biomass

| | | |
|---|---|---|
| | | Yarrowia |
| | Standard Feed: | Y4305 F1B1 Feed: |
| Day 0 | Day 112 | Day 112 |

Gross Parameters

| | | | |
|---|---|---|---|
| Dry Matter | 28.7 ± 0.3 | 29.7 ± 0.40 | 28.9 ± 0.1 |
| Protein | 21.7 ± 0.2 | 19.5 ± 0.30 | 19.9 ± 0.2 |
| Fat | 8.1 ± 0.8 | 10.0 ± 0.37 | 8.8 ± 0.14 |

Carotenoid Content (mg/kg)

| | | | |
|---|---|---|---|
| Astaxanthin | 0.5 ± 0 | 1.87 ± 0.12 | 1.05 ± 0.08 |
| Idoxanthin | 0.2 ± 0.03 | 0.47 ± 0.12 | 0.73 ± 0.13 |

Fatty Acid Composition

| | | | |
|---|---|---|---|
| 14:0 | 0.33 ± 0.03 | 0.28 ± 0.01 | 0.17 ± 0.01 |
| 14:1, n-5 | 0.02 ± 0.00 | 0.01 ± 0.001 | 0.01 ± 0.001 |
| 15:0 | 0.03 ± 0.00 | 0.02 ± 0.002 | 0.02 ± 0.001 |
| 16:0 | 1.06 ± 0.1 | 1.14 ± 0.04 | 1.00 ± 0.01 |
| 16:1, n-5 | nd | 0.01 ± 0.0 | 0.01 ± 0.001 |
| 16:1, n-7 | 0.32 ± 0.04 | 0.24 ± 0.01 | 0.16 ± 0.008 |
| 16:1, n-9 | 0.03 ± 0.01 | 0.03 ± 0.002 | 0.02 ± 0.001 |
| 16:3, n-4 | 0.03 ± 0.00 | 0.02 ± 0.001 | 0.01 ± 0.001 |
| 17:0 | nd | 0.02 ± 0.001 | 0.02 ± 0.002 |
| 17:1, n-7 | nd | 0.02 ± 0.001 | 0.01 ± 0.001 |
| 18:0 | 0.21 ± 0.02 | 0.28 ± 0.01 | 0.28 ± 0.004 |
| 18:1, n-11 | 0.09 ± 0.01 | 0.10 ± 0.005 | 0.05 ± 0.01 |
| 18:1, n-7 | 0.21 ± 0.02 | 0.19 ± 0.01 | 0.17 ± 0.004 |
| 18:1, n-9 | 1.15 ± 0.10 | 1.45 ± 0.04 | 1.37 ± 0.01 |
| 18:2, n-6 | 0.30 ± 0.03 | 1.69 ± 0.05 | 1.99 ± 0.08 |
| 18:3, n-3 | 0.13 ± 0.01 | 0.22 ± 0.01 | 0.25 ± 0.01 |
| 18:3, n-4 | 0.02 ± 0.00 | 0.01 ± 0.001 | 0.01 ± 0.001 |
| 18:3, n-6 | nd | 0.06 ± 0.003 | 0.06 ± 0.004 |
| 20:0 | 0.01 ± 0.00 | 0.02 ± 0.001 | 0.02 ± 0.001 |
| 20:1, n-11 | 0.14 ± 0.01 | 0.12 ± 0.003 | 0.10 ± 0.003 |
| 20:1, n-7 | nd | 0.02 ± 0.001 | 0.01 ± 0.001 |
| 20:1, n-9 | 0.46 ± 0.04 | 0.46 ± 0.02 | 0.25 ± 0.01 |
| 20:2, n-6 | 0.04 ± 0.00 | 0.10 ± 0.01 | 0.11 ± 0.01 |
| 20:3, n-3 | 0.02 ± 0.00 | 0.02 ± 0.001 | 0.02 ± 0.002 |
| 20:3, n-6 | 0.02 ± 0.00 | 0.07 ± 0.001 | 0.08 ± 0.002 |
| 20:4, n-3 | 0.08 ± 0.01 | 0.08 ± 0.004 | 0.04 ± 0.002 |
| 20:4, n-6 | 0.04 ± 0.00 | 0.04 ± 0.001 | 0.04 ± 0.001 |
| 20:5, n-3 | 0.39 ± 0.04 | 0.4 ± 0.04 | 0.34 ± 0.03 |
| 22:1, n-11 | 0.52 ± 0.05 | 0.57 ± 0.02 | 0.27 ± 0.01 |
| 22:1, n-7 | 0.09 ± 0.01 | 0.07 ± 0.004 | 0.06 ± 0.002 |
| 22:1, n-9 | 0.06 ± 0.00 | 0.06 ± 0.002 | 0.03 ± 0.001 |
| 22:4, n-6 | 0.03 ± 0.00 | 0.02 ± 0.001 | 0.02 ± 0.001 |
| 22:5, n-3 | 0.16 ± 0.02 | 0.15 ± 0.01 | 0.13 ± 0.01 |
| 22:6, n-3 | 1.02 ± 0.08 | 0.76 ± 0.03 | 0.63 ± 0.03 |
| 24:0 | 0.01 ± 0.01 | 0.02 ± 0.002 | 0.02 ± 0.001 |
| 24:1, n-9 | 0.05 ± 0.01 | 0.04 ± 0.002 | 0.03 ± 0.001 |
| EPA + DHA | 1.41 ± 0.12 | 1.20 ± 0.05 | 1.00 ± 0.02 |
| Sum of n-3 | 1.82 ± 0.16 | 1.53 ± 0.07 | 1.41 ± 0.03 |
| Sum of n-6 | 0.45 ± 0.04 | 1.23 ± 0.04 | 2.26 ± 0.07 |
| Saturated | 1.67 ± 0.16 | 1.79 ± 0.06 | 1.52 ± 0.02 |
| fatty acids | | | |

*nd = not detected

The gross parameters of protein, dry matter, and fat were very comparable between fish fed the two aquaculture feed formulations. Astaxanthin was slightly less in fish fed the aquaculture feed formulation including 20% Yarrowia Y4305 F1B1 biomass.

With respect to fatty acids, the dominant fatty acids are identified in bold font in Table 11. The sum of EPA plus DHA [“EPA+DHA”] in the fish at 112 days was similar in fish fed the standard feed formulation and in fish fed the feed formulation including 20% Yarrowia Y4305 F1B1 biomass at (i.e., 1.2 g/100 g and 1 g/100 g, respectively).

Overall, the data suggest that the EPA available in the Yarrowia Y4305 F1B1 biomass is being adsorbed by the fish and converted to DHA. This demonstrates that Yarrowia Y4305 F1B1 biomass can be used in place of fish oil in aquaculture feed formulations for salmon with minimal impact on the health and growth of the cultured animal.

Finally, it is noted that the level of 18:2, n-6 (linoleic acid) in the Yarrowia Y4305 F1B1 biomass results in a significantly higher total omega-6 content [“Sum of n-6”] in fish fed the feed formulation including 20% Yarrowia Y4305 F1B1 biomass, as opposed to in fish fed the standard aquaculture feed formulation. In commercial practice, fish oil is typically blended with vegetable oils (e.g., soybean oil or rapeseed oil), which also have higher levels of 18:2, n-6. Thus, it is anticipated that a less significant difference would be noted in the 18:2, n-6 content in fish fed a commercial feed containing soybean or rapeseed oil as opposed to in fish fed the aquaculture feed formulation including 20% Yarrowia Y4305 F1B1 biomass.

Based on the results herein, wherein Yarrowia Y4305 F1B1 biomass was successfully used in place of fish oil in aquaculture feed formulations for salmon, and the calculations set forth in Example 4, one of skill in the art could readily determine the appropriate amount of Yarrowia Y4305 biomass or Yarrowia Y4305 F1B1 biomass to be included in various other aquaculture feed formulations suitable for culture of other fin fish species. The Yarrowia Y4305 or Y4305 F1B1 biomass could be used to reduce or replace the total fish oil content in any desired aquaculture feed formulation. If all other components of the aquaculture feed formulation containing the Yarrowia Y4305 or Y4305 F1B1 biomass were comparable to those of the standard feed formulation for a particular fin fish (i.e., in terms of nutritional benefit, digestability, palatability, etc.), with the exception of the Yarrowia Y4305 or Y4305 F1B1 biomass, one of skill in the art would predict that the modified aquaculture feed formulations containing the Yarrowia Y4305 or Y4305 F1B1 biomass would be suitable for the health and growth of the fin fish.

### Example 6

### Alternate Strains of Yarrowia lipolytica Suitable for Aquaculture Feed Formulations

The purpose of this Example is to provide alternate microbial biomass that could be used as a source of EPA and optionally DHA, for incorporation into an aquaculture feed formulation that provides a ratio of concentration of EPA to concentration of DHA which is greater than 2:1 based on the individual concentrations of EPA and DHA, each measured as a weight percent of total fatty acids in the aquaculture feed formulation. One skilled in the art of aquaculture feed formulation would readily be able to determine the appropriate amount of biomass (or, e.g., biomass and oil supplement) to include in the aquaculture feed formulation, to achieve the desired level of EPA and, optionally, DHA.

Although Examples 1-5 demonstrate production and use of aquaculture feed formulations including Yarrowia lipolytica Y4305 and Yarrowia lipolytica Y4305 F1B1 biomass, the present disclosure is by no means limited to aquaculture feed formulations comprising this particular biomass. Numerous other species and strains of oleaginous yeast genetically engineered for production of ω-3 PUFAs are suitable sources of micobial oils comprising EPA. As an example, one is referred to the representative strains of the oleaginous yeast Yarrowia lipolytica described in Table 12. These include the following strains that have been deposited with the ATCC: Y. lipolytica strain Y2096 (producing EPA; ATCC Accession No. PTA-7184); Y. lipolytica strain Y2201 (producing EPA; ATCC Accession No. PTA-7185); Y. lipolytica strain Y3000 (producing DHA; ATCC Accession No. PTA-7187); Y. lipolytica strain Y4128 (producing EPA; ATCC Accession No. PTA-8614); Y. lipolytica strain Y4127 (producing EPA; ATCC Accession No. PTA-8802).

Additionally, Y. lipolytica strain Y8406 (producing EPA; ATCC Accession No. PTA-10025), Y. lipolytica strain Y8412 (producing EPA; ATCC Accession No. PTA-10026) and Y. lipolytica strain Y8259 (producing EPA; ATCC Accession No. PTA-10027) are described in U.S. patent application Ser. No. 12/814,815, filed Jun. 14, 2010 [E.I. duPont de Nemours & Co., Inc., Attorney Docket No. “CL4674USNA”, hereby incorporated herein by reference].

Thus, for example, Table 12 shows microbial hosts producing from 4.7% to 61.8% EPA of total fatty acids, and optionally, 5.6% DHA of total fatty acids.

TABLE 12
Lipid Profiles of Representative Yarrowia lipolytica Strains Engineered to Produce ω-3/ω-6 PUFAs

| | | ATCC | Fatty Acid Content (As A Percent [%] of Total Fatty Acids) | | | | | | | | | | | | | | |
|---|---|---|---|---|---|---|---|---|---|---|---|---|---|---|---|---|---|
| | | Deposit | | | | | | 18:3 | | 20:2 | | | | | | | TFAs % |
| Strain | Reference | No. | 16:0 | 16:1 | 18:0 | 18:1 | 18:2 | (ALA) | GLA | (EDA) | DGLA | ARA | ETA | EPA | DPAn-3 | DHA | DCW |
| EU | U.S. Pat. | — | 19 | 10.3 | 2.3 | 15.8 | 12 | 0 | 18.7 | — | 5.7 | 0.2 | 3 | 10.3 | — | — | 36 |
| Y2072 | Appl. Pub. | — | 7.6 | 4.1 | 2.2 | 16.8 | 13.9 | 0 | 27.8 | — | 3.7 | 1.7 | 2.2 | 15 | — | — | — |
| Y2102 | No. 2006- | — | 9 | 3 | 3.5 | 5.6 | 18.6 | 0 | 29.6 | — | 3.8 | 2.8 | 2.3 | 18.4 | — | — | — |
| Y2088 | 0115881- | — | 17 | 4.5 | 3 | 2.5 | 10 | 0 | 20 | — | 3 | 2.8 | 1.7 | 20 | — | — | — |
| Y2089 | A1 | — | 7.9 | 3.4 | 2.5 | 9.9 | 14.3 | 0 | 37.5 | — | 2.5 | 1.8 | 1.6 | 17.6 | — | — | — |
| Y2095 | | — | 13 | 0 | 2.6 | 5.1 | 16 | 0 | 29.1 | — | 3.1 | 1.9 | 2.7 | 19.3 | — | — | — |
| Y2090 | | — | 6 | 1 | 6.1 | 7.7 | 12.6 | 0 | 26.4 | — | 6.7 | 2.4 | 3.6 | 26.6 | — | — | 22.9 |
| Y2096 | | PTA- | 8.1 | 1 | 6.3 | 8.5 | 11.5 | 0 | 25 | — | 5.8 | 2.1 | 2.5 | 28.1 | — | — | 20.8 |
| | | 7184 | | | | | | | | | | | | | | | |
| Y2201 | | PTA- | 11 | 16.1 | 0.7 | 18.4 | 27 | 0 | — | 3.3 | 3.3 | 1 | 3.8 | 9 | — | — | — |
| | | 7185 | | | | | | | | | | | | | | | |
| Y3000 | U.S. Pat. | PTA- | 5.9 | 1.2 | 5.5 | 7.7 | 11.7 | 0 | 30.1 | — | 2.6 | 1.2 | 1.2 | 4.7 | 18.3 | 5.6 | — |
| | No. | 7187 | | | | | | | | | | | | | | | |
| | 7,550,286 | | | | | | | | | | | | | | | | |
| Y4001 | U.S. Pat. | — | 4.3 | 4.4 | 3.9 | 35.9 | 23 | 0 | — | 23.8 | 0 | 0 | 0 | — | — | — | — |
| Y4036 | Appl. Pub. | — | 7.7 | 3.6 | 1.1 | 14.2 | 32.6 | 0 | — | 15.6 | 18.2 | 0 | 0 | — | — | — | — |
| Y4070 | No. 2009- | — | 8 | 5.3 | 3.5 | 14.6 | 42.1 | 0 | — | 6.7 | 2.4 | 11.9 | — | — | — | — | — |
| Y4086 | 0093543- | — | 3.3 | 2.2 | 4.6 | 26.3 | 27.9 | 6.9 | — | 7.6 | 1 | 0 | 2 | 9.8 | — | — | 28.6 |
| Y4128 | A1 | PTA- | 6.6 | 4 | 2 | 8.8 | 19 | 2.1 | — | 4.1 | 3.2 | 0 | 5.7 | 42.1 | — | — | 18.3 |
| | | 8614 | | | | | | | | | | | | | | | |
| Y4158 | | — | 3.2 | 1.2 | 2.7 | 14.5 | 30.4 | 5.3 | — | 6.2 | 3.1 | 0.3 | 3.4 | 20.5 | — | — | 27.3 |
| Y4184 | | — | 3.1 | 1.5 | 1.8 | 8.7 | 31.5 | 4.9 | — | 5.6 | 2.9 | 0.6 | 2.4 | 28.9 | — | — | 23.9 |
| Y4217 | | — | 3.9 | 3.4 | 1.2 | 6.2 | 19 | 2.7 | — | 2.5 | 1.2 | 0.2 | 2.8 | 48.3 | — | — | 20.6 |
| Y4259 | | — | 4.4 | 1.4 | 1.5 | 3.9 | 19.7 | 2.1 | — | 3.5 | 1.9 | 0.6 | 1.8 | 46.1 | — | — | 23.7 |
| Y4305 | | — | 2.8 | 0.7 | 1.3 | 4.9 | 17.6 | 2.3 | — | 3.4 | 2 | 0.6 | 1.7 | 53.2 | — | — | 27.5 |
| Y4127 | Int'l. App. | PTA- | 4.1 | 2.3 | 2.9 | 15.4 | 30.7 | 8.8 | — | 4.5 | 3.0 | 3.0 | 2.8 | 18.1 | — | — | — |
| | Pub. No. | 8802 | | | | | | | | | | | | | | | |
| Y4184 | WO | — | 2.2 | 1.1 | 2.6 | 11.6 | 29.8 | 6.6 | — | 6.4 | 2.0 | 0.4 | 1.9 | 28.5 | — | — | 24.8 |
| | 2008/ | | | | | | | | | | | | | | | | |
| | 073367 | | | | | | | | | | | | | | | | |
| Y8406 | U.S. | PTA- | 2.6 | 0.5 | 2.9 | 5.7 | 20.3 | 2.8 | — | 2.8 | 2.1 | 0.5 | 2.1 | 51.2 | — | — | 30.7 |
| | Patent | 10025 | | | | | | | | | | | | | | | |
| Y8412 | Applica- | PTA- | 2.5 | 0.4 | 2.6 | 4.3 | 19.0 | 2.4 | — | 2.2 | 2.0 | 0.5 | 1.9 | 55.8 | — | — | 27.0 |
| | tion | 10026 | | | | | | | | | | | | | | | |
| Y8647 | 12/ | — | 1.3 | 0.2 | 2.1 | 4.7 | 20.3 | 1.7 | — | 3.3 | 3.6 | 0.7 | 3.0 | 53.6 | — | — | 37.6 |
| Y9028 | 814815 | — | 1.3 | 0.2 | 2.1 | 4.4 | 19.8 | 1.7 | — | 3.2 | 2.5 | 0.8 | 1.9 | 54.5 | — | — | 39.6 |
| Y9481 | | — | 2.5 | 0.5 | 3.1 | 4.7 | 11.0 | 0.6 | — | 2.6 | 3.6 | 0.9 | 2.1 | 60.9 | — | — | 35.0 |
| Y9502 | | — | 2.5 | 0.5 | 2.9 | 5.0 | 12.7 | 0.9 | — | 3.5 | 3.3 | 0.8 | 2.4 | 57.0 | — | — | 37.1 |
| Y8145 | | — | 4.3 | 1.7 | 1.4 | 4.8 | 18.6 | 2.8 | — | 2.2 | 1.5 | 0.6 | 1.5 | 48.5 | — | — | 23.1 |
| Y8259 | | PTA- | 3.5 | 1.3 | 1.3 | 4.8 | 16.9 | 2.3 | — | 1.9 | 1.7 | 0.6 | 1.6 | 53.9 | — | — | 20.5 |
| | | 10027 | | | | | | | | | | | | | | | |
| Y8367 | | — | 3.7 | 1.2 | 1.1 | 3.4 | 14.2 | 1.1 | — | 1.5 | 1.7 | 0.8 | 1.0 | 58.3 | — | — | 18.4 |
| Y8672 | | — | 2.3 | 0.4 | 2.0 | 4.0 | 16.1 | 1.4 | — | 1.8 | 1.6 | 0.7 | 1.1 | 61.8 | — | — | 26.5 |

1. An aquaculture feed composition comprising:
(a) at least one source of eicosapentaenoic acid [“EPA”] and optionally at least one source of docosahexanoic acid [“DHA”], wherein said source can be the same or different; and,
(b) a ratio of concentration of EPA to concentration of DHA which is greater than 2:1 based on the individual concentrations of EPA and DHA in the aquaculture feed composition.

2-18. (canceled)

19. An aquaculture feed composition comprising fishmeal, Yarrowia lipolytica biomass, eicosapentaenoic acid (EPA) and docosahexaenoic acid (DHA), wherein the ratio of the EPA to the DHA, each measured as a weight percentage of the total fatty acids in the feed composition, is at least about 9:1, and wherein the total amount of the EPA and the DHA measured as a weight percentage of the feed composition is at least about 3.13%.

20. The aquaculture feed composition of claim 19, further comprising vegetable oil.

21. The aquaculture feed composition of claim 20, wherein the feed composition comprises at least 15% by weight vegetable oil.

22. The aquaculture feed composition of claim 19, wherein the Yarrowia lipolytica biomass comprises a single strain of Yarrowia lipolytica.

23. The aquaculture feed composition of claim 19, wherein the feed composition does not comprise purified fish oil.

24. The aquaculture feed composition of claim 19, which is a salmon feed composition.

25. The aquaculture feed composition of claim 24, which is an Atlantic salmon feed composition or a coho salmon feed composition.

26. A method of making an aquaculture feed composition according to claim 19, said method comprising:
a) providing fishmeal and Yarrowia lipolytica biomass;
b) providing additional feed components; and
c) contacting (a) and (b) to make an aquaculture feed composition according to claim 19.
